(19) United States
(12) Patent Application Publication
(10) Pub. No.: US 2008/0140837 A1
(43) Pub. Date: Jun. 12, 2008

(54) Social Online Memory Systems

(75) Inventors: Josh R. Hoover, Mesa, AZ (US); Geoffery D. Hoffman, Tempe, AZ (US)

Correspondence Address: LAW OFFICE OF ANDREW P. LAHSER, PLC, 13239 N. LA MONTANA, SUITE 215, FOUNTAIN HILLS, AZ, 85268, US

(73) Assignee: Harver Group LLC, Fountain Hills, AZ (US)

(21) Appl. No.: 11/923,466

(22) Filed: Oct. 24, 2007

Related U.S. Application Data
(60) Provisional application No. 60/862,762, filed on Oct. 24, 2006.
(60) Provisional application No. 60/854,331, filed on Oct. 24, 2006.

(51) Int. Cl. G06F 15/173

(52) U.S. Cl. 709/225

(57) ABSTRACT

A system is described having the steps of permitting authoring of a digital-content by a first person; and restricting transmitting, across a globally-connected electronic-network, of the digital-content to a second person; when the step of restricting electronically transmitting includes the steps of determining the age of the first person; determining the age of the second person; allowing electronically transmitting whenever the age of the first person is unregulated and the age of the second person is unregulated; and allowing electronically transmitting whenever the age-difference between the age of the first person and the age of the second person, differ by less than a effective amount, the first person is associated with an organization, and the second person is associated with same organization.

### CROSS REFERENCE TO RELATED APPLICATIONS

The present application is related to prior provisional application entitled “ONLINE SOCIAL MEMORY SYSTEMS” bearing Ser. No. 60/862,762 filed Oct. 24, 2006, the contents of which are incorporated herein by this reference and are not admitted to be prior art with respect to the present invention by the mention in this cross-reference section.

The present application is related to prior provisional application entitled “ONLINE SOCIAL MEMORY SOFTWARE SYSTEMS” bearing Ser. No. 60/854,331 filed Oct. 24, 2006, the contents of which are incorporated herein by this reference and are not admitted to be prior art with respect to the present invention by the mention in this cross-reference section.

### SUMMARY

In accordance with a preferred embodiment hereof, this system provides for receiving a roster of a organization; wherein the roster includes a person associating with the organization; storing a set of a digital-medium; wherein the digital-medium includes a likeness of the person; transmitting electronically the digital-medium, whereby performing a transmission; counting the transmission, whereby determining a count; and selecting, using the count, the digital-medium from the set, whereby selecting a select digital-medium. It further provides for when the digital-medium includes a photograph. It further provides for when the digital-medium includes an audio recording. It further provides for when the digital-medium includes a movie. It further provides for when the digital-medium includes a digital-medium selected from the group consisting of photograph, audio recording, movie, and combinations thereof. It further provides for when the organization includes a school. It further provides for when the organization includes a religious group. It further provides for when the organization includes an athletic group. It further provides for requiring, prior to the step of transmitting electronically, proving association with the organization. It further provides for distributing the select digital-medium on a globally-connected electronic-network. It further provides for distributing the select digital-medium on a physical-medium. It further provides for distributing the select digital-medium on a wireless telephone network. It further provides for when the physical-medium includes a CD-ROM. It further provides for when the physical-medium includes a DVD. It further provides for when the physical-medium includes a book. It further provides for when the physical-medium includes a physical-medium selected from the group consisting of CD-ROM, DVD, book, and combinations thereof. It further provides for when the step of distributing further includes the step of encrypting the select digital-medium. It further provides for when the step of distributing further includes the step of frustrating copying of the select digital-medium. It further provides for the steps of requiring, prior to the step of transmitting electronically, proving association with the organization; distributing the select digital-medium on a physical-medium; wherein the organization includes a school; wherein the digital-medium includes a digital-medium selected from the group consisting of photograph, audio recording, movie, and combinations thereof, and wherein the physical-medium includes a physical-medium selected from the group consisting of CD-ROM, DVD, book, and combinations thereof. It further provides for when the steps of encrypting the select digital-medium; and frustrating copying of the select digital-medium.

In accordance with a preferred embodiment hereof, this system provides for receiving a set of a digital-medium from a organization; dividing the set into a free portion and a paid portion; distributing to a person, associated with the organization, the set; allowing performing of the free portion; collecting a payment from the person; allowing performing, after the step of collecting a payment, of the paid portion; and paying, to the organization, a portion of the payment. It further provides for when the step of dividing further includes the step of resolving the digital-medium into a low resolution and a high resolution. It further provides for when the step of dividing further includes the step of selecting a popular portion of the set and a unpopular portion of the set. It further provides for when the step of dividing further includes the step of categorizing the digital-medium into a category. It further provides for when the organization includes a school; and wherein the category is selected from the group consisting of sports, music, events, clubs, and combinations thereof. It further provides for when the step of distributing further includes the step of electronically transmitting a portion of the set over a globally-connected electronic-network. It further provides for when the step of distributing further includes the step of publishing the set in a physical-medium. It further provides for when the physical-medium includes a CD-ROM. It further provides for when the physical-medium includes a DVD. It further provides for when the physical-medium includes a book. It further provides for when the physical-medium includes a physical-medium selected from the group consisting of CD-ROM, DVD, book, and combinations thereof. It further provides for when the organization includes a school. It further provides for when the organization includes a religious group. It further provides for when the organization includes an athletic team. It further provides for when the step of requiring, prior to the step of distribution, proving a association between a purchaser and the organization, whereby a proof is established. It further provides for when the step of requiring wherein a proof includes possessing of a physical-medium.

In accordance with a preferred embodiment hereof, this system provides for permitting authoring of a digital-content by a first person; and restricting transmitting, across a globally-connected electronic-network, of the digital-content to a second person; wherein the step of restricting electronically transmitting includes the steps of determining the age of the first person; determining the age of the second person; allowing electronically transmitting whenever the age of the first person is unregulated and the age of the second person is unregulated; and allowing electronically transmitting whenever the age-difference between the age of the first person and the age of the second person, differ by less than a effective amount, the first person and the second person is associated with a organization, and the second person is associated with the organization. It further provides for when the digital-content includes a photograph. It further provides for when the digital-content includes an audio recording. It further provides for when the digital-content includes a movie. It further provides for when the digital-content includes a text. It further provides for when the digital-content includes a blog post. It further provides for when the digital-content includes a instant message. It further provides for when the digital-content includes an email. It further provides for when the digital-content includes a digital-content selected from the group consisting of photograph, audio recording, movie, text, blog post, instant message, email, and combinations thereof. It further provides for when the organization includes a school. It further provides for when the organization includes a religious group. It further provides for when the organization includes an athletic team. It further provides for when the step of determining the age of the first person further includes the step of estimating the age of the first person using the school grade-level of the first person; and the step of determining the age of the second person further includes the step of estimating the age of the second person using the school grade-level of the second person.

In accordance with a preferred embodiment hereof, this system provides for receiving a roster of a organization; wherein the roster includes a name of a person associated with the organization; electronically storing a digital-medium; wherein the digital-medium includes a likeness of the person; assisting relating the digital-medium with the name; wherein the step of assisting relating further includes the steps of presenting, over a electronic-network, the likeness within a structured document; accepting inputting of a letter; presenting, by modifying at least a portion of the structured document, a portion of the roster; wherein the portion excludes an other name; wherein the other name includes the roster and does not include the letter; allowing selecting the name from the portion of the roster, whereby a relationship is formed between the digital-medium and the name; and electronically storing the relationship. It further provides for when the organization includes a school. It further provides for when the organization includes a religious group. It further provides for when the organization includes an athletic group. It further provides for when the digital-medium includes a photograph. It further provides for when the digital-medium includes an audio recording. It further provides for when the digital-medium includes a movie. It further provides for when the digital-medium includes a digital-medium selected from the group consisting of photograph, audio recording, movie, or combinations thereof. It further provides for when the electronic-network includes a globally-connected electronic-network. It further provides for when the electronic-network includes a wireless telephone network. It further provides for when the step of accepting inputting further includes accepting inputting of at least three letters. It further provides for when the name includes a first name. It further provides for when the name includes a last name. It further provides for when the name includes a nick name. It further provides for when the name includes a name selected from the group consisting of first name, last name, middle name, nick name, or combinations thereof. It further provides for when electronically linking the name to the digital-medium using the relationship. It further provides for when the step of electronically linking further includes the step of manufacturing a physical-medium; wherein the physical-medium includes the digital-medium; wherein the physical-medium further includes the name; and wherein the physical-medium further includes the relationship. It further provides for when the physical-medium further includes a CD-ROM. It further provides for when the physical-medium further includes a DVD. This system provides for the step of electronically indexing the digital-medium to the name using the relationship. It further provides for when the step of manufacturing a physical-medium; wherein the physical-medium includes the digital-medium; wherein the physical-medium further includes the name; and wherein the physical-medium further includes the relationship. It further provides for when the physical-medium further includes a CD-ROM. It further provides for when the physical-medium further includes a DVD. It further provides for when the step of presenting, by modifying at least a portion of the structured document, further includes using javascript. It further provides for when the step of presenting, by modifying at least a portion of the structured document, further includes using xml. It further provides for when the step of presenting, by modifying at least a portion of the structured document, further includes the steps of asynchronously receiving, via a httprequest object, the letter; and asynchronously sending, via the httprequest object, the portion, in response to the step of asynchronously receiving. It further provides for when the step of presenting, over the electronic-network, further includes the step of using a xml document; and updating the xml document using the portion.

### BRIEF DESCRIPTION OF THE DRAWINGS

FIG. 1 shows a diagram view illustrating an organization interacting with system according to an embodiment of the present invention.

FIG. 2 shows a diagram view illustrating an organization transmitting a roster to an electronic database and members registering with the electronic database according to the embodiment of FIG. 1.

FIG. 3 shows a flowchart view illustrating steps for transmitting a school rooster and allowing student signup according to another embodiment of the present invention.

FIG. 4 shows a computer screenshot view illustrating a school rooster according to another embodiment of the present invention.

FIG. 5 shows a computer screenshot view illustrating a rooster upload process according to the embodiment of FIG. 4.

FIG. 6 shows a computer screenshot view illustrating an administrative process for adding a student to the roster according to the embodiment of FIG. 4.

FIG. 7 shows a computer screenshot view illustrating an administrative process for adding staff to the roster according to the embodiment of FIG. 4.

FIG. 8 shows a diagram view illustrating an organization sending digital and physical content to the electronic database according to another embodiment the present invention.

FIG. 9 shows a flowchart view illustrating steps for transmitting digital and physical content to an electronic database according to another embodiment of the present invention.

FIG. 10 shows a diagram view illustrating relating the likeness contained on a digital medium with a member's name on the roster according to another embodiment of the present invention.

FIG. 11 shows a flowchart view illustrating relating the likeness contained on a digital medium with a member's name on the roster according to another embodiment of the present invention.

FIG. 12 shows a computer screenshot view illustrating an interactive, browser based web page for associating roster names to digital medium according to another embodiment of the present invention.

FIG. 13 shows a computer screenshot view illustrating member's names appearing after keystrokes are transmitted according to the embodiment of FIG. 12.

FIG. 14 shows a computer screenshot view illustrating searching for photos to associate with member's names according to the embodiment of FIG. 12.

FIG. 15 shows a computer screenshot view illustrating adding sub-categories for classifying digital media according to the embodiment of FIG. 12.

FIG. 16 shows a computer screenshot view illustrating maintaining sub-categories for classifying digital media according to the embodiment of FIG. 12.

FIG. 17 shows a diagram view illustrating counting usage of digital media according to another embodiment of the present invention.

FIG. 18 shows a flowchart view illustrating counting usage of digital media according to another embodiment of the present invention.

FIG. 19 shows a diagram view illustrating restricting transmitting of digital content according to another embodiment of the present invention.

FIG. 20 shows a flowchart view illustrating restricting transmitting of digital content according to another embodiment of the present invention.

FIG. 21 shows a diagram view illustrating distributing digital media according to another embodiment of the present invention.

FIG. 22 shows a flowchart view illustrating distributing digital media according to another embodiment of the present invention.

FIG. 23 shows a diagram view illustrating sharing revenue associated with the distribution of digital media according to another embodiment of the present invention.

FIG. 24 shows a flowchart view illustrating sharing revenue associated with the distribution of digital media according to another embodiment of the present invention.

### DETAILED DESCRIPTION

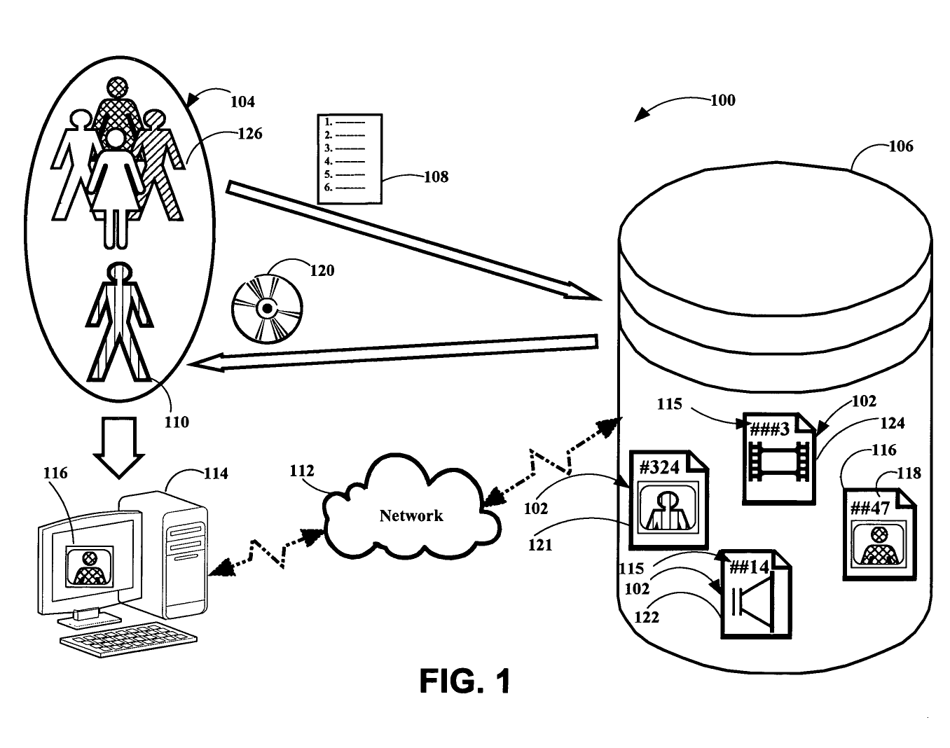

FIG. 1 shows a diagram view illustrating an organization interacting with system 100 according to an embodiment of the present invention. System 100 provides for storing and displaying different types of digital media 102 on behalf of organization 104, as shown. Organization 104 creates accounts on database 106 by transmitting roster 108 to the database 106, as shown. Database 106 creates at least one account for each person on roster 108. Database 106, after setting up each account, allows member 110 of organization 104 to electronically access database 106, through an electronic network 112 using computer 114, as shown. Member 110 can view, listen to, or watch digital medium 116 on computer 114, as shown. Database 106 increments counter 118 each time member 110 views, or requests electronic transmission of, digital medium 116. Alternatively, digital medium 116 can be distributed by disk 120, as shown. Database 106 selects digital medium 116 from the set of images because counter 118, which is associated with digital medium 116, is higher than other counters 115 associated with digital media 102.

Digital media 102 may be digital photograph 121, digital-audio recording 122, digital movie 124, as shown. Digital media 102 may be any of a variety of digital media, such as, for example, any photograph, any audio recording, any movie, other media that captures the likeness of individuals, or combinations thereof. Digital photograph 121 can be created directly using a digital camera. Digital photograph 121 can be created by scanning paper photographs or photographic negatives using a scanner. Digital movie 124 can be created using a video camera directly. Digital movie 124 can be created using a film movie camera and later converted into digital format. Digital-audio recording 122 can be created using a sound recorder, such as, for example, a tape recorder, a dictation machine, or other recording equipment, and later converted into a digital format. Digital-audio recording 122 can be created directly by digital recording devices, such as, for example, a computer configured with a microphone, a digital recording device, etc.

Digital media 102 may be stored in a relational database table. For example, the following table definition may be suitable for storing photographs in a relational database.

photo

| field | Type | null | default |
|---|---|---|---|
| photoid | int(10) | no | |
| phototypeid | tinyint(3) | no | 0 |
| schoolid | int(10) | no | 0 |
| activitylevelid | tinyint(1) | no | 0 |
| genderid | tinyint(1) | no | 0 |
| groupid | int(10) | no | 0 |
| catid | int(11) | no | 0 |
| subid | int(10) | no | 0 |
| uluserid | int(10) | yes | null |
| cwuserid | int(10) | yes | null |
| originalname | varchar(32) | yes | null |
| photo | varchar(255) | yes | null |
| caption | mediumtext | yes | null |
| status | tinyint(4) | no | 0 |
| imagedata | Blob | no | |

Another method for storing digital media 102 includes storing media in files in a file system. Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, etc., may suffice.

For this application and the following claims, the word “set” should have its normal mathematical meaning: “a collection of one or more elements.”

Upon reading the teachings of this specification, those with ordinary skill in the art will now realize that, under appropriate circumstances, considering such issues as imaging technology, media importance, user preference, economic considerations, advances and technology, etc., other types of digital medium may suffice.

Organization 104 can be a group of related persons, who share common beliefs and work toward a mutual goal, task or undertaking. Organization 104 can have some method for determining whether any given person is, or is not, a member. Organization 104 can have some method for determining whether a person is associated with member 110, such as, for example, whether a person is a parent, guardian, brother, sister, extended family member, or other close personal relation of a member 110.

Alternatively, organization 104 can be a school, university, college, or other educational institution. Organization 104 can be a portion of such a school, such as, for example, the marching band, the science club, the quiz bowl team, the computer club, and other extra-curricular activity. Member 110 can be a student, staff, faculty or other employee of organization 104.

Information related to organization 104 may be stored in a relational database table. For example, the following table definition may be suitable for storing information related to organization 104 in a relational database.

School

| Field | type | null | default |
|---|---|---|---|
| schoolid | int(10) | no | |
| schoolname | varchar(100) | no | |
| schoolgovid | varchar(15) | yes | null |
| emmschoolcode | varchar(20) | yes | null |
| address1 | varchar(255) | yes | null |
| address2 | varchar(255) | yes | null |
| city | varchar(100) | yes | null |
| state | varchar(100) | yes | null |
| zip | varchar(20) | yes | null |
| phone | varchar(20) | yes | null |

In this example, the field named “schoolgovid” indicates a relationship between schools. Another method for storing information related to organization 104 includes storing information in flat files in a file system of a computer operating system. Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, etc., may suffice.

Alternatively, organization 104 can be a religious group, such as for example, a church, a congregation, a synagogue, a mosque, a temple, a parish, a basilica, a monastery, a place of worship, or a place of religious instruction or training. Organization 104 can be affiliated with any religious denomination, such as, for example, Christianity, Islam, Hinduism, Buddhism, Chinese folk religion, Pagan, Judaism, or other denomination. Member 110 can be a priest, monk, worshiper, initiate, or a practitioner.

Alternatively, organization 104 can be an athletic group, such as, for example, a professional basketball team (NBA), a professional baseball team (MLB), a professional hockey team (NHL), professional bowling, professional poker tournaments, martial arts tournaments, swimming teams, college basketball, college football, soccer teams, high school sports teams, little-league sports, chess tournaments, bowling leagues, bicycling tournaments, gymnastics tournaments, cheerleading squads, and other sports teams or other organized sports tournaments. Member 110 can be an athlete (professional, amateur, youth or otherwise), coach, or staff.

Upon reading the teachings of this specification, those with ordinary skill in the art will now realize that, under appropriate circumstances, considering such issues as organizational identity, relationships between people, advances in law, user preference, economic considerations, etc., other types of organizations, such as, for example, families, civic organizations, hobbyist organization, political organization, etc., may suffice.

During meetings, events, or gatherings of organization 104, digital media 102 will be made that include the likeness of member 110 or other members 126. For example, organization 104 may photograph its football games; organization 104 may record its marching band; organization 104 may film its play; organization 104 may televise its professional sports team's games or competitions; organization 104 may record its religious instruction; organization 104 may photograph its celebrations or festivals. While creating digital media 102, the likeness of member 110 or other members 126 will be captured in digital media 102; such likeness may include the appearance of member 110 or other members 126, the sound of the voice of member 110 or other members 126, the sound of a musical instrument played by member 110 or other members 126, behavioral mannerisms of member 110 or other members 126, or other qualities captured by digital media 102 that aid in the remembrance of member 110 or other members 126.

Organization 104 may use database 106 to store digital media 102. Database 106 receives roster 108, which contains a list of members of organization 104. Database 106 is configured to allow access to each of the members who's name appears on roster 108. Organization 104 does not need to transmit the birthday of members who are on roster 108. Organization 104 does not need to transmit the email address of members who are on roster 108. Organization 104 may setup database 106 through the efforts of it members. Database 106 need not collect any personally identifying information about member 110. Organization 104 may alternatively setup database 106 through the efforts of others. Database 106 need not be directly affiliated with organization 104.

Electronic network 112 may be used to transmit digital media to and from database 106, as shown. Electronic network 112 may be a globally connected computer network, such as, for example, the Internet. Electronic network 112 may be a wireless telephony network, such as, for example, a cellular phone system. Upon reading the teachings of this specification, those with ordinary skill in the art will now realize that, under appropriate circumstances, considering such issues as advances in electronic networking, advances in digital media playback technology and standards, user preference, economic considerations, etc., other types of electronic networks, such as, for example, local area networks, public switched telephone network (PSTN), digital electronic networks, global systems for mobile communications (GSM), code division multiple access (CDMA), etc., may suffice.

Computer 114 may communicate with electronic network 112, as shown. Computer 114 may be a personal computer, as shown. Computer 114 may be a digital telephone. Computer 114 may be a personal data assistant (PDA) or blackberry. Computer 114 should be adapted to send, receive and playback digital media 102, as shown. Upon reading the teachings of this specification, those with ordinary skill in the art will now realize that, under appropriate circumstances, considering such issues as advances in hardware, advances in telephony, advances in portable multimedia playback devices, user preference, economic considerations, etc., other types of computers, such as, for example, personal digital assistant (PDA), laptop computer, dedicated custom-hardware computing device, etc., may suffice.

Disk 120 may be adapted to store digital media 102. Digital disk may be a compact disk read-only-memory (CDROM). Disk 120 may be a digital video disk, digital versatile disk, etc. (DVD). Upon reading the teachings of this specification, those with ordinary skill in the art will now realize that, under appropriate circumstances, considering such issues as advances in disk technology, advances in digital media storage formats, user preference, economic considerations, etc., other types of digital disks, such as, for example, mini disks, optical disks, etc., may suffice.

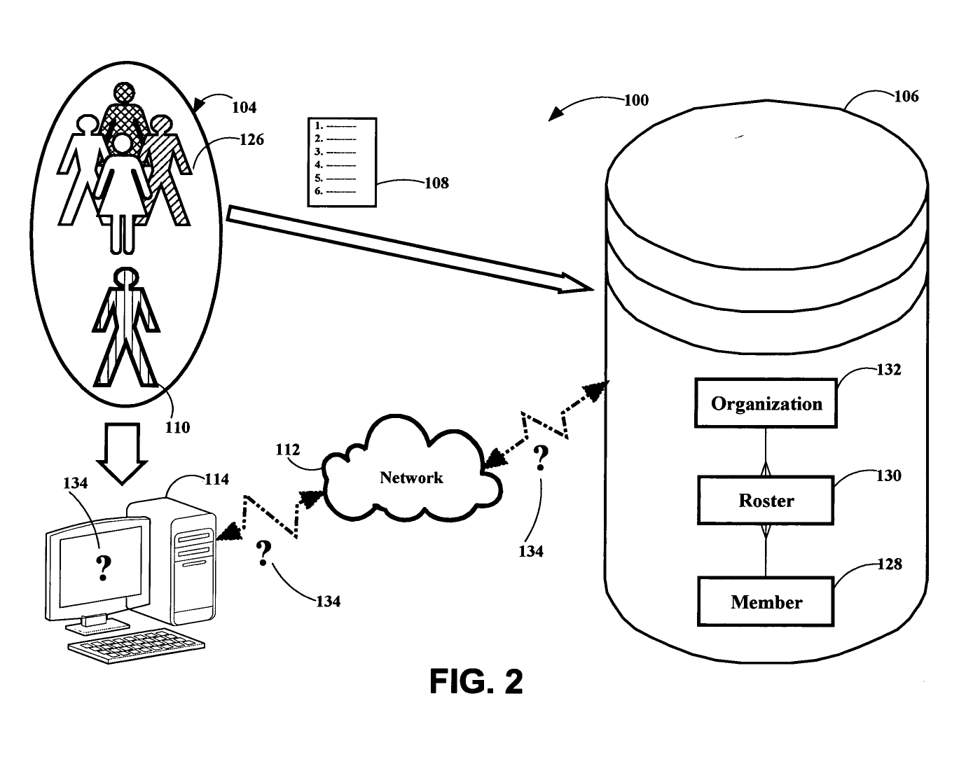

FIG. 2 shows a diagram view illustrating an organization transmitting a roster 108 to database 106 and member 110 registering with database 106 according to the embodiment of FIG. 1. Database 106 may contain at least three database tables to store account information about members, organizations and their rosters, as shown. Member table 128 contains information about members, such as, for example, password, username, password hint, etc. Roster table 130 contains information, such as, for example, first name, last name, organization, member id, etc. Roster table 130 contains information about members from member table 128 that belong to organization 104, as shown. Organization table 132 contains information about organization 104, such as, for example, organization name, organization type, number of members, etc.

After transmitting roster 108 to database 106, database 106 may be configured to provide at least one account for each name on roster 108, such as, for example, one account for member 110, other accounts for other members 126. Database 106 may further be configured to provide accounts to others who share a legal relationship to member 110 or other members 126, such as, for example, parents, guardians, spouses, agents, or appointments of member 110 or other members 126. In FIG. 2, member 110 provides account information 134, such as, for example, a username and related password, to database 106, as shown. After verifying that account information 134 relates to a record in member table 128, electronic database allows access and permits further interaction.

Database 106 may be configured to restrict access by any person other than those explicitly authorized. In other words, by default, other members 126 of organization 104 may authenticate with database 106 using account information, such as, for example, username and related password, prior to any further interaction. Persons legally associated with member 110 and other members 126 may authenticate with database 106 using account information, such as, for example, a username and related password, prior to any further interaction.

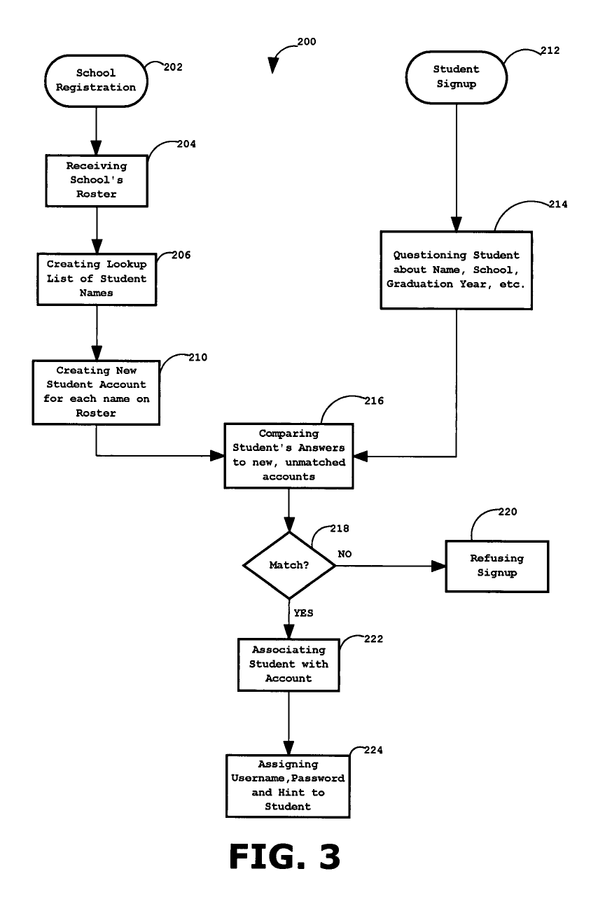

FIG. 3 shows a flowchart view illustrating system 200 having steps for transmitting a school rooster and allowing student signup according to another embodiment of the present invention. During step 202, the school begins the registration process by preparing a roster of students. During step 204, system 200 receives the roster from the school. During step 206, system 200 creates a lookup list having the names of all students, faculty, staff and others listed on the roster. This lookup list may be used to associate the names of students, faculty, staff and others with digital media. During step 210, system 200 creates an account, without authentication credentials, such as, for example, username and related password, for each name on the roster.

During step 212, a student listed on the roster signs up for an account. During step 214, the student may answer questions to help verify that the student is the person listed on the roster. For example, system 200 may ask questions such as: “what is your first name?”; “what is your last name?”; what is the name of your school?”; “what is your grade?”; “what is your graduation year?”. System 200 may ask questions that don't personally identify the student, but do indicate that the student has knowledge of the specific school the student is attending, and the student's relationship to the school.

During step 216, system 200 compares the student's answers to the information contained in the roster, such as, for example, first name, last name, school name, grade, year of graduation, etc. During step 216, system 200 compares the student's answers to other information about the school. During step 218, system 200 determines if the information matches. During step 220, system 200 denies further access to the student because the student's answers did not correspond to the expected answers. During step 222, system 200 associates the student with a new user record. During step 224, system 200 allows the student to select a username, related password, and password hint.

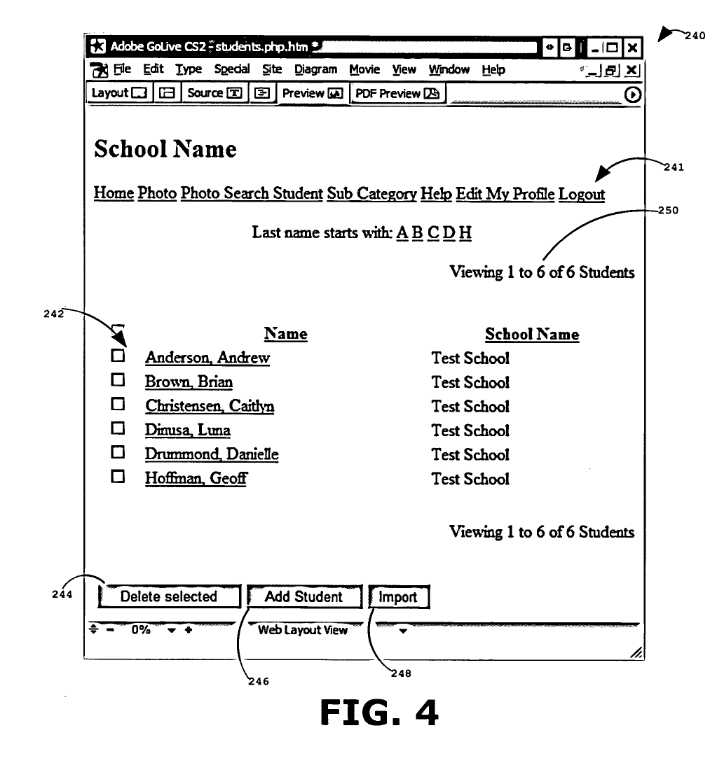

FIG. 4 shows a computer screenshot view illustrating a school rooster according to another embodiment of the present invention. System 240 may display school roster 242 in a web browser, such as, for example, Internet Explorer, Mozilla Firefox, Opera, Safari, etc, as shown. Navigation bar 241 displays links for navigating to other portions of system 240, as shown.

School roster 242 contains the names of students, faculty, staff and other people associated with the school, as shown. Clicking on a name in school roster 242 allows editing of student information on a related student record stored in an electronic database. Selecting the checkbox before a name on school roster 242 and then clicking delete button 244 removes the student record associated with the student name from the electronic database, thereby removing the student name from the school roster, as shown. Clicking add button 246 displays a new web page that allows creating a new student record to the school roster, as shown. Clicking import button 248 displays a web page that allows importing a list of students to the school roster and associated student table in the electronic database. Totals text 250 displays the total number of student records in the electronic database; in other words, totals text 250 displays the number of students on the school roster, as shown.

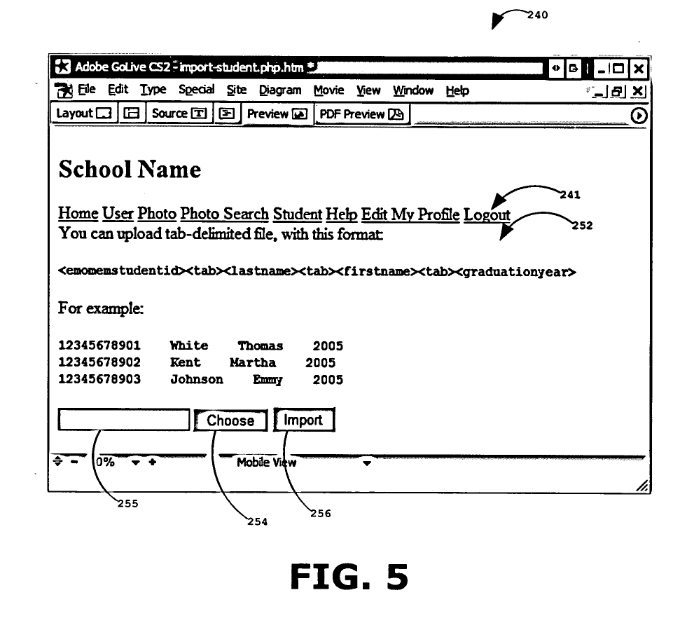

FIG. 5 shows a computer screenshot view illustrating system 240 displaying a rooster upload process web page according to the embodiment of FIG. 4. System 240 displays instructions 252, which describe the file format for a rooster. Instructions 252 specify that the file may be tab-delimited, as shown. Instructions 252 specify that the file may include a unique identifier named “emomemstudentid,” as shown. Instructions 252 specify that the file may include first name, last name, and graduation year, as shown. Clicking file-select button 254 displays an operating system dialogue box that allows selection of a file, as shown. Import-file editbox 255 displays the name of the file that will be imported after clicking file-select button 254 and selecting a file, as shown. Clicking import button 256 creates student records in the electronic database, if the file is formatted as specified by instructions 252, otherwise system 200 will reject the file, or a portion of the file, with an error message.

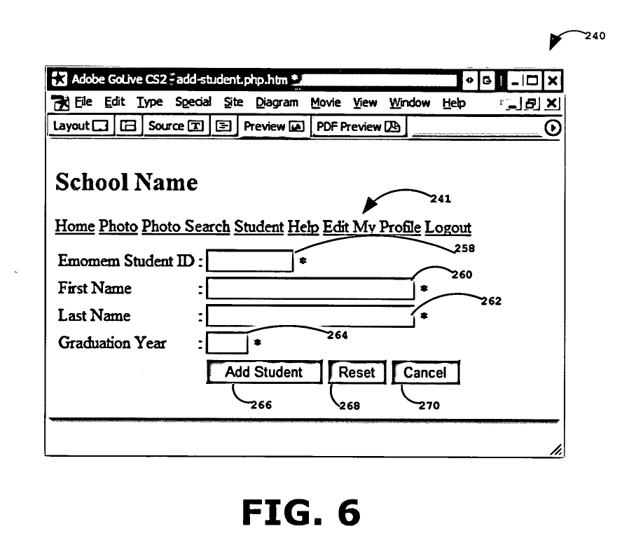

FIG. 6 shows a computer screenshot view illustrating an administrative process for adding a student to the roster according to the embodiment of FIG. 4. System 240 displays a web form for adding or maintaining student information in the electronic database, as shown. ID field 258 contains the information from “emomemstudentid”, mentioned above, as shown. First name field 260 allows entry and editing of the first name of the student, as shown. Last name field 262 allows entry and editing of the last name of the student, as shown. Graduation year field 264 allows entry and editing of the graduation year for the student, as shown. Fields marked with an asterisk (*) are required fields and may not be saved with no information or space information or other NULL indicators, as shown. Clicking the add-student button 266 creates a new student record using the ID field 258 as a key field. Alternately, clicking the add-student button 266 modifies an existing record with the same ID field 258. Clicking the cancel button 270 will return to the navigation screen without adding or changing any student information.

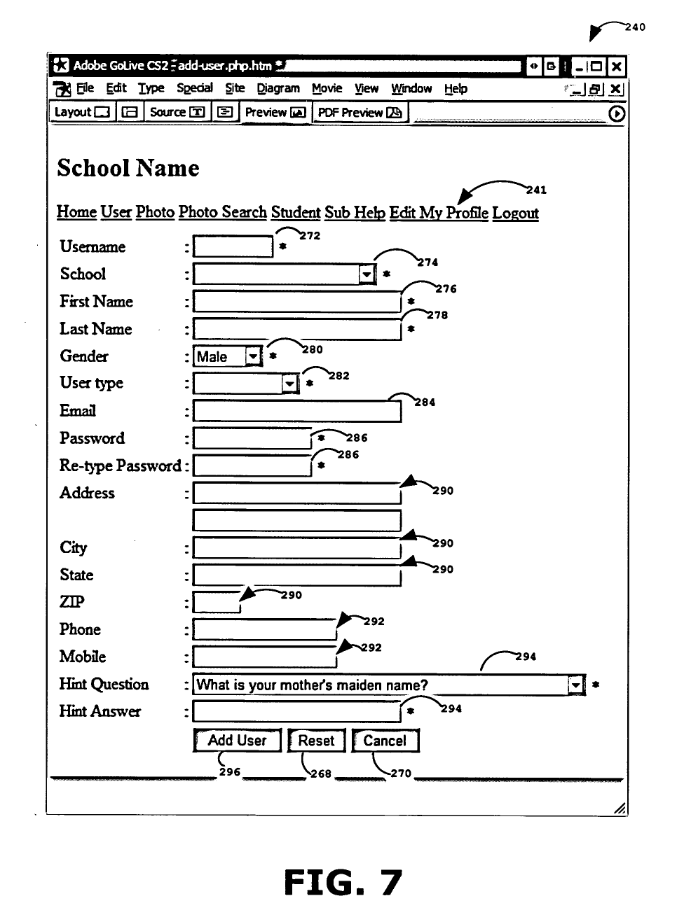

FIG. 7 shows a computer screenshot view illustrating an administrative process for adding staff to the roster according to the embodiment of FIG. 4. System 240 displays a web page for editing users of system 240. Users of the system may be, for example, faculty, staff, teachers, persons associated with maintaining system 240, or other appointees of the school. Username field 272 allows entry and editing of the username, as shown. School field 274 contains the name of the school, which with the user is associated, as shown. First name field 276 contains the first name of the user, as shown. Last name field 278 contains the last name of the user, as shown. Gender field 280 contains either “Male” or “Female”, as shown.

User type field 282 contains an indicator, or key, for the type of user, such as, for example, student, teacher, principal, staff, employee, coach, admin, etc. Email field 284 allows entry and editing of the email address of the user, as shown. Password fields 286 allow double entry of a hidden password to enter or change the password information, as shown. Address fields 290 allow entry and editing of the postal address information for the user, as shown. Phone number fields 292 allow entry and editing of phone numbers associated with the user, as shown. Password hint 294 allows entry and editing of a password question and answer that permits resetting password fields 286, as shown.

Clicking the add-user button 296 creates a new user record using the username field 272 as a key field. Alternately, clicking the add-user button 296 modifies an existing record with the same username field 272.

Some fields may not be available for all user types, such as, for example, system 240 may prevent storing email field 284 or address fields 290 information for certain record types, such as students. Some users may have permission to change all fields, such as, for example, a student user may not change school field 274, first name field 276, last name field 278, user type field 282, etc.

System 240 may create the student records show in FIG. 6 prior to the user records shown in FIG. 7. System 240 may require the student. System 240 may be configured to not allow adding user account record shown in FIG. 7 unless a rooster record shown in FIG. 6 is available to, and known to, a student.

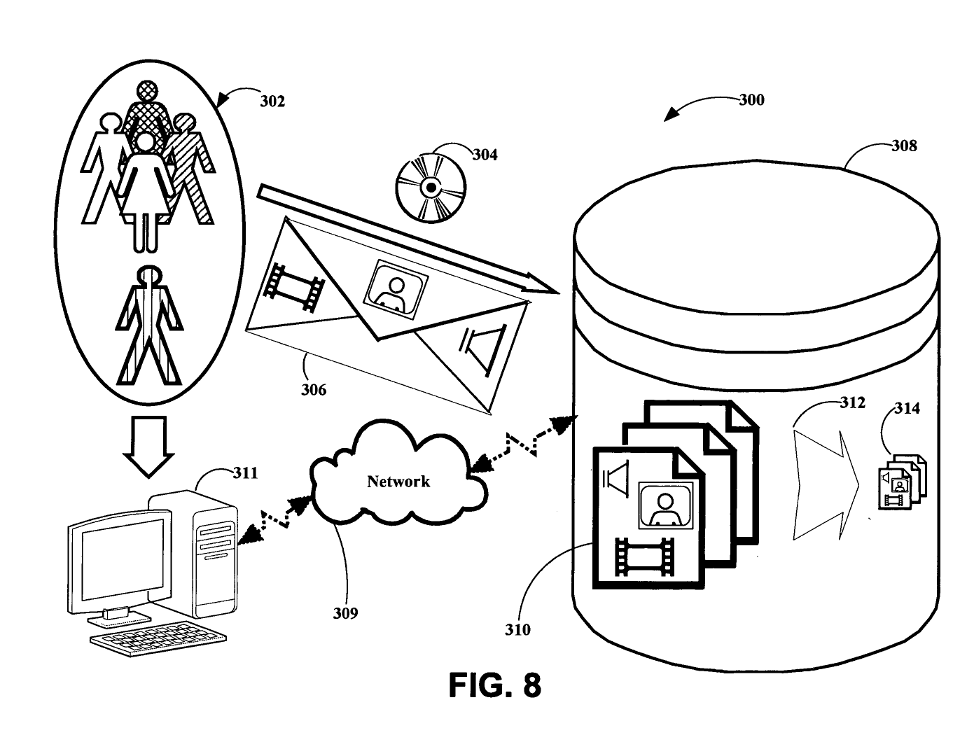

Information related to student records of FIG. 6 and user account records of FIG. 8 may be stored in a relational database table. For example, the following table definitions may be suitable for storing such information in a relational database.

| | | |
|---|---|---|
| type | null | default |

classlevel

| | | |
|---|---|---|
| field | | |
| classlevelid | tinyint(1) | no |
| classlevel | varchar(15) | no |

employee

| | | | |
|---|---|---|---|
| employeeid | int(10) | no | |
| schoolgovid | varchar(15) | no | |
| emomemid | varchar(11) | no | |
| thumb | varchar(255) | no | |
| image | varchar(255) | no | |
| first | varchar(50) | no | |
| last | varchar(50) | no | |
| subid | int(10) | no | 0 |
| unlock_code | varchar(50) | yes | null |

employee_to_position

| | | | |
|---|---|---|---|
| empposid | int(10) | no | |
| employeeid | int(10) | no | 0 |
| positionid | int(10) | no | 0 |

position

| | | | |
|---|---|---|---|
| id | int(10) | no | |
| schoolgovid | bigint(20) | no | 0 |
| position | varchar(50) | no | |

school_to_classlevel

| | | | |
|---|---|---|---|
| schooltosclasslevelid | int(10) | no | |
| schoolid | int(10) | no | 0 |
| classlevelid | int(10) | no | 0 |

student

| | | | |
|---|---|---|---|
| studentid | int(10) | no | |
| schoolgovid | varchar(15) | no | |
| emomemid | int(9) | no | 0 |
| emomemstudentid_old | varchar(11) | no | |
| fname | varchar(50) | no | |
| mname | varchar(50) | yes | null |
| lname | varchar(50) | no | |
| gradyear | varchar(4) | no | |
| classlevelid | tinyint(1) | no | 0 |
| typeid | int(10) | no | 0 |
| thumb | varchar(255) | no | |
| image | varchar(255) | no | |
| unlock_code | varchar(50) | yes | null |

user

| | | | |
|---|---|---|---|
| userid | int(10) | no | |
| username | blob | no | |
| emomemid | int(9) | yes | 0 |
| usertypeid | tinyint(1) | yes | null |
| schoolid | int(10) | yes | null |
| genderid | tinyint(3) | yes | null |
| fname | varchar(50) | yes | null |
| mname | varchar(20) | yes | null |
| lname | varchar(50) | yes | null |
| email | varchar(100) | yes | null |
| password | blob | yes | null |
| address | varchar(100) | yes | null |
| address2 | varchar(100) | yes | null |
| city | varchar(100) | yes | null |
| state | varchar(100) | yes | null |
| zip | varchar(20) | yes | null |
| phone | varchar(20) | yes | null |
| mobile | varchar(20) | yes | null |
| hintqid | tinyint(1) | yes | null |
| hintanswer | varchar(100) | yes | null |
| isover13 | char(0) | yes | null |
| isover18 | char(0) | yes | null |
| studentid | int(10) | yes | null |
| employeeid | int(10) | yes | null |
| gradyear | int(4) | yes | null |
| thumb | varchar(255) | yes | null |
| image | varchar(255) | yes | null |
| subid | int(10) | yes | null |
| unlock_code | varchar(50) | yes | null |

user_to_school

| | | | |
|---|---|---|---|
| userid | int(10) | no | 0 |
| schoolid | int(10) | no | 0 |

usertype

| | | | |
|---|---|---|---|
| usertypeid | tinyint(3) | no | |
| usertypename | varchar(40) | yes | null |

year

| | | | |
|---|---|---|---|
| Field | | | |
| year | mediumint(4) | no | 0 |

Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, flat files, etc., may suffice.

FIG. 8 shows a diagram view illustrating system 300, which allows organization 302 to send multi-media content on digital disk 304 and physical format 306 to electronic database 308 according to the embodiment of FIG. 1. Alternately, organization 302 sends multi-media content to electronic database 308 via network 309, as shown. Electronic database 308 may be adapted to receive digital media 310 over network 309 using any of a variety of networking protocols, such as, for example, hyper text transport protocol (HTTP), file transport protocol (FTP), secure file transport protocol (SFTP), electronic mail (SMTP), etc. Organization 302 sends digital media across network 309 using computer 311, as shown.

Electronic database 308 may be any software system capable of storing digital media and permitting access based on any of a variety of authentication schemes. Some combinations of software systems capable of such functions include, but are not limited to, Oracle, Microsoft SQL Server, MySQL, Windows, Linux, Apache, Microsoft Internet Information Server, PHP, ASP, etc., and combinations thereof. Such software system may run on one or more physical computers. Upon reading the teachings of this specification, those with ordinary skill in the art will now realize that, under appropriate circumstances, considering such issues as database features, programming languages, operating system functions, user preference, economic considerations, etc., other types of electronic databases, such as, for example, DB2, flat file, C, C++, C#, Unix, Macintosh, etc., may suffice.

Electronic database 308 may accept photographs, movies, sound recordings, or other suitable content in any computer file format. Electronic database 308 may accept photographs, movies, sound recordings, or other suitable content, in physical format 306 and may convert physical format 306 into such suitable content into digital media 310. Electronic database 308 may accept photographs, movies, sound recordings, or other suitable content in a computer file format that is not suitable for electronic transmission, such as, for example transmission across a globally connected computer network. Electronic database 308 may convert these photographs, movies, sound recordings, non-standard file formats, and other suitable content into a format that is compatible with electronic transmission using conversion process 312. Electronic database 308 may accept photographs, movies, sound recordings, or other suitable content by delivery of physical media. Electronic database 308 may accept photographs, movies, sound recordings, or other suitable content by electronic transmission over a globally connected computer network. Electronic database 308 may accept photographs, movies, sound recordings, or other suitable content on recordable, physical digital disk, such as, for example, compact disk, digital video disk, etc. Electronic database 308 may use, or interface with, directly or indirectly, scanning equipment to create digital files form the physical format, such as, for example, image scanners, slide scanners, etc. Electronic database 308 may use, or interface with, recording equipment to create digital sound records. Upon reading the teachings of this specification, those with ordinary skill in the art will now realize that, under appropriate circumstances, considering such issues as in internetworking technology, programming languages, operating system functions, user preference, economic considerations, digital media file formats, etc., other methods of converting physical formats into digital media may suffice.

Electronic database 308 may convert, using conversion process 312, into a format that complies with industry standards, such as, for example, the various RFC documents used in internetworking and computer network programming, such as, for example, on the Internet. Electronic database 308 may convert photographs into JPEG file format, PNG file format, or GIF file format, of suitable dimension and file size for effective transmission across a globally connected computer network. Electronic database 308 may convert movies into QuickTime file format, AVI file format, or Windows Media file format, using an effective dimension, frame rate and files size for effective transmission across a globally connected computer network. Electronic database 308 may convert sound recordings into MP3 file format, AAC file format, OGG file format, with or without compression, such that the sound recording may be effectively transmitted across a globally connected computer network. Electronic database 308 may create a representative sampling of digital media 310. Conversion process 312 generates network-transmission-effective digital-media 314, as shown. Upon reading the teachings of this specification, those with ordinary skill in the art will now realize that, under appropriate circumstances, considering such issues as advances in internetworking technology, programming languages, operating system functions, user preference, economic considerations, digital media file formats, etc., other methods of converting digital media into network-effective format, may suffice.

Upon reading the teachings of this specification, those with ordinary skill in the art will now realize that, under appropriate circumstances, considering such issues as available network bandwidth, advances in digital media technology, advances in internetworking and computer network programming, digital rights management advances, user preference, economic considerations, etc., other types of digital media, such as, for example, Real Audio, MPEG-4, WMA, WAV, etc., may suffice.

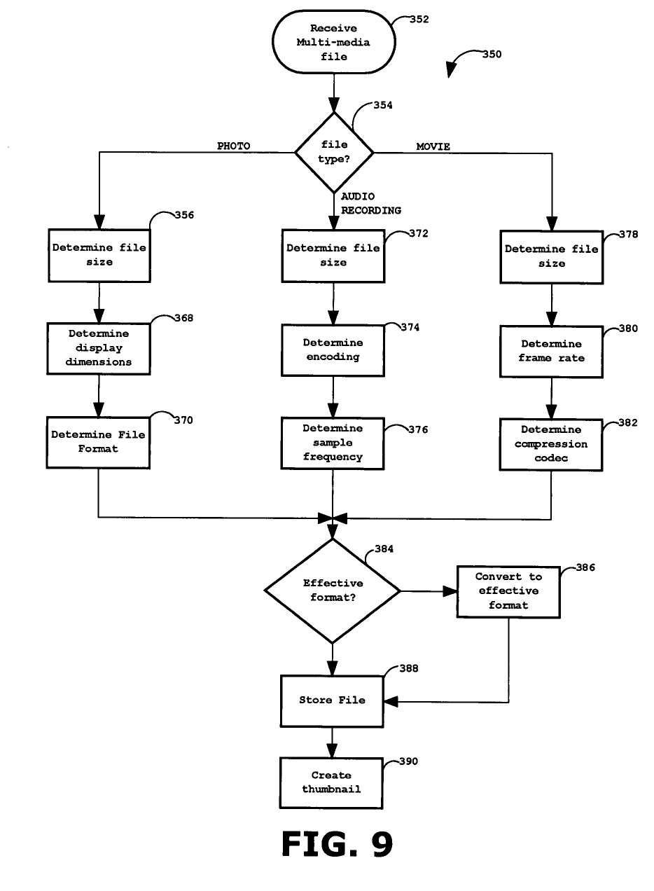

FIG. 9 shows a flowchart view illustrating system 350 performing steps for transmitting digital and physical content to an electronic database according to another embodiment of the present invention. During step 352, an organization member sends a multi-media file to system 350, as shown. System 350 determines the file type of the multi-media file during step 354, as shown. If the file type is a photo or image, system 350 determines the file size during step 356. Next, during step 368, system 350 determines the display dimension, usually in pixels, for the photo. During step 370, system 350 determines the file format, such as, for example, JPEG, GIF, etc. If the file type is an audio recording, during step 372, system 350 determines the file size of the audio recording. During step 374, system 350 determines the encoding of the audio recording, such as, for example, MP3, AAC, etc. During step 376, system 350 determines the sample frequency of the audio recording, such as, for example, stereo/mono, frequency, etc. If the file type is a movie, during step 378, system 350 determines the file size of the movie. During step 380, system 350 determines the frame rate of the movie. During step 382, system 350 determines the compression codec, or compression method, such as, for example, Sorenson, H.264, Cinepack, Indeo, Microsoft, Microsoft RLE, etc.

During step 384, system 350 determines if the various parameters of the file are effective for network transmission. For example, TIF files and BMP files are not viewable in most standard web browsers, so system 350 may convert the files to JPEG, which are render-able in nearly all web browsers. For example, WAV files are not compressed, so system 350 may convert WAV files to MP3 files for efficient network transmission and playback. During step 386, system 350 determines conversion parameters and converts the media to network-effective standards. During step 388, system 350 may store the file. During step 390, system 350 may make a small thumbnail, sample, or other representative indicia of the file. System 350 may store the thumbnail associated with the file.

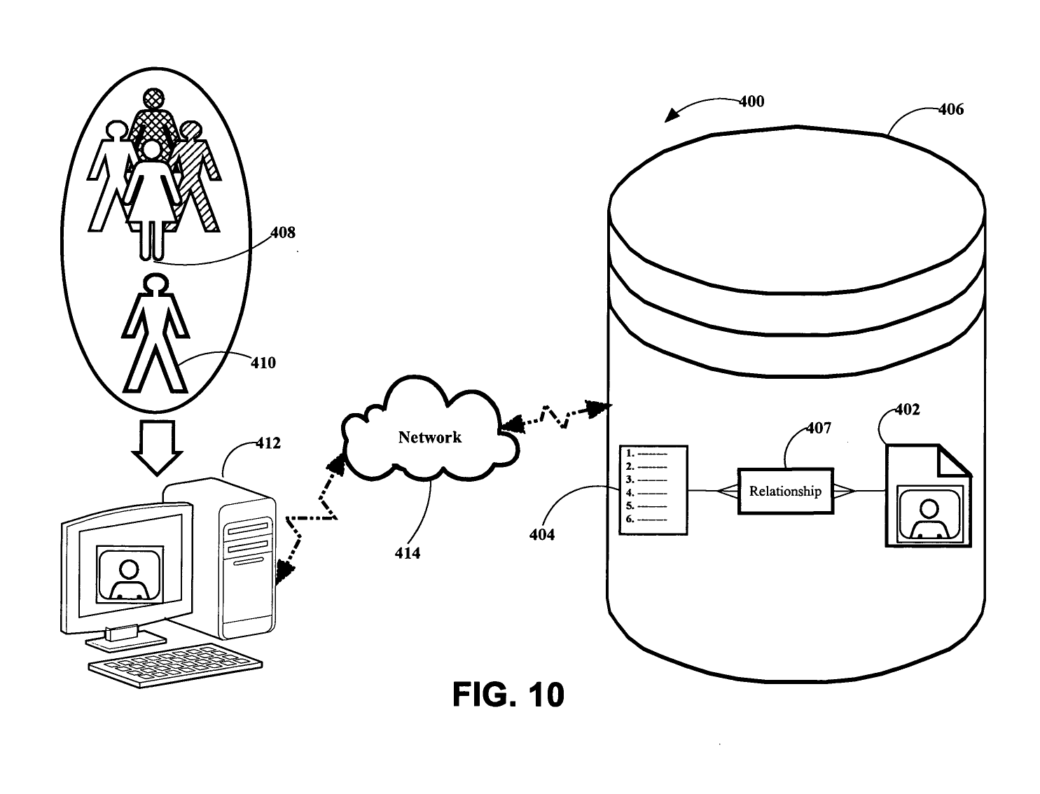

FIG. 10 shows a diagram view illustrating system 400 relating the likeness contained on digital medium 402 with a member's name on roster 404 according to another embodiment of the present invention. Database 406 may allow storing relationship 407 between digital medium 402 and one or more names on roster 404. Database 406 may allow relationship 407 to indicate that the likeness of member 408 is included on digital medium 402. Relationship 407 may indicate the order of appearance of the likeness of various members, thereby allowing a viewer to relate the name from the roster with the likeness portrayed in the digital medium. For example, database 406 may contain a photograph, the caption of the photograph would contain the name of the member; this caption and its relation to the photograph are stored in a relationship. For example, database 406 may contain a group portrait, the caption for the group portrait would contain the names of the members from left to right, top row to bottom row; this caption and its relationship to the group portrait would be stored in a relationship. For example, database 406 may contain a recording of a marching band, a list of instruments and the members playing the instruments would be related with the sound recording, and stored in a relationship. For example, database 406 may contain a movie, the credits for this movie would list the names of the members in order of appearance in a relationship.

System 400 may use relationship 407 to create electronic links, such as, for example, hypertext links, URL links, indices, etc., to assist navigation from a members name to a multimedia file or vice versa.

System 400 allows member 410 to assist in relating digital medium 402 with roster 404, as shown. System 400 transmits the likeness contained in digital medium 402 to computer 412 across electronic network 414, as shown. System 400 transmits at least a portion of roster 404 to computer 412 across electronic network 414, as shown. Member 410 selects a name or names that correspond to the likeness contained in digital medium 402, as shown. System 400 stores relationship 407, as shown.

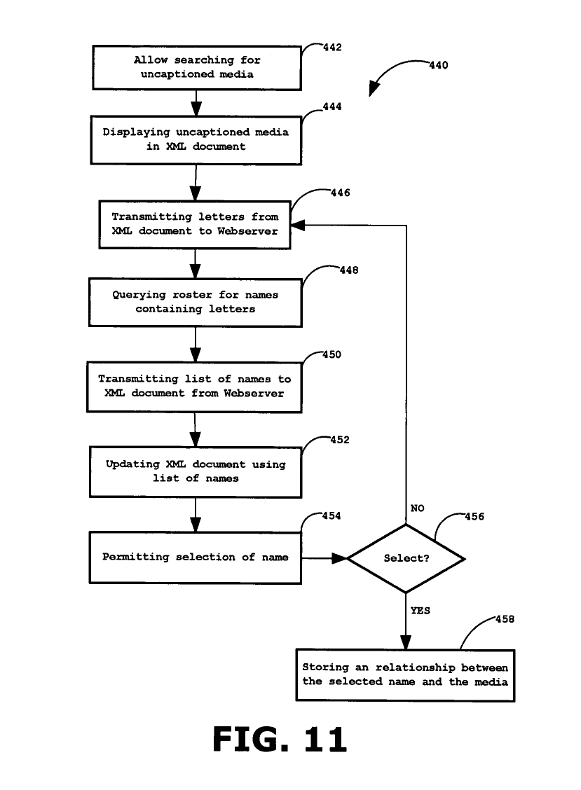

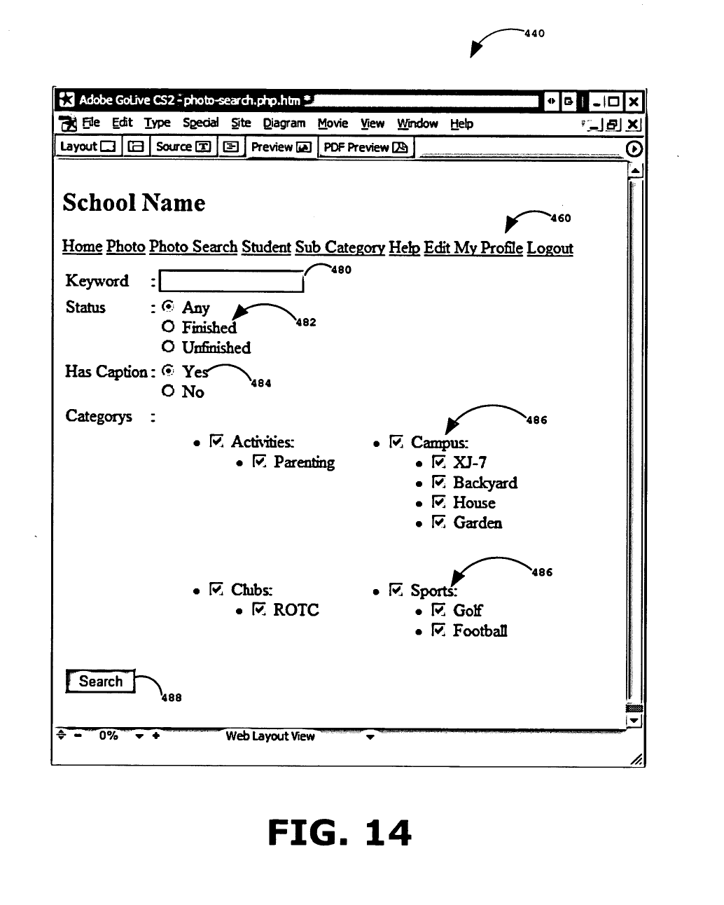

FIG. 11 shows a flowchart view illustrating system 440 relating the likeness contained on a digital medium with a member's name on the roster according to another embodiment of the present invention. During step 442, system 440 allows a member to search for media that is not related to any member on the roster, as shown in FIG. 14, below. During step 444, system 440 displays media to the member in a structured document, such as, for example, an XML (Extensible Markup Language) document, HTML (HyerText Markup Language) document, etc. During step 444, system 440 includes an embedded program to transmit letters and receive structured document updates within the structured document, such as, for example, a javascript program, an embedded java applet, a flash program, etc. During step 446, system 440 receives one or more letters typed by the member into the structured document, having been transmitted by the embedded program, such as, for example, by a javascript asynchronously calling an httprequest object, etc. Alternately, the embedded program is configured to delay transmission until a minimum number of letters has been typed, such as for example, two letters, three letters, four letters, etc. During step 448, system 440 queries the roster for names using the transmitted letters and system 440 creates a name-list including at least a portion of the names on the roster. During step 450, system 440 transmits the name-list to the structured document. During step 452, the embedded program receives the name-list and updates the structured document to include the name-list for display to the member. During step 454, the member can see the name-list and select from the name list or type additional letters. During step 456, system 440 will receive additional letters and re-execute these steps whenever a name is not selected but additional letters have been typed. As described, this system allows for updating the structured document without using an HTTP POST request, which completely rebuilds the structured document. During step 458, system 440 may store a relationship between the selected name and the media.

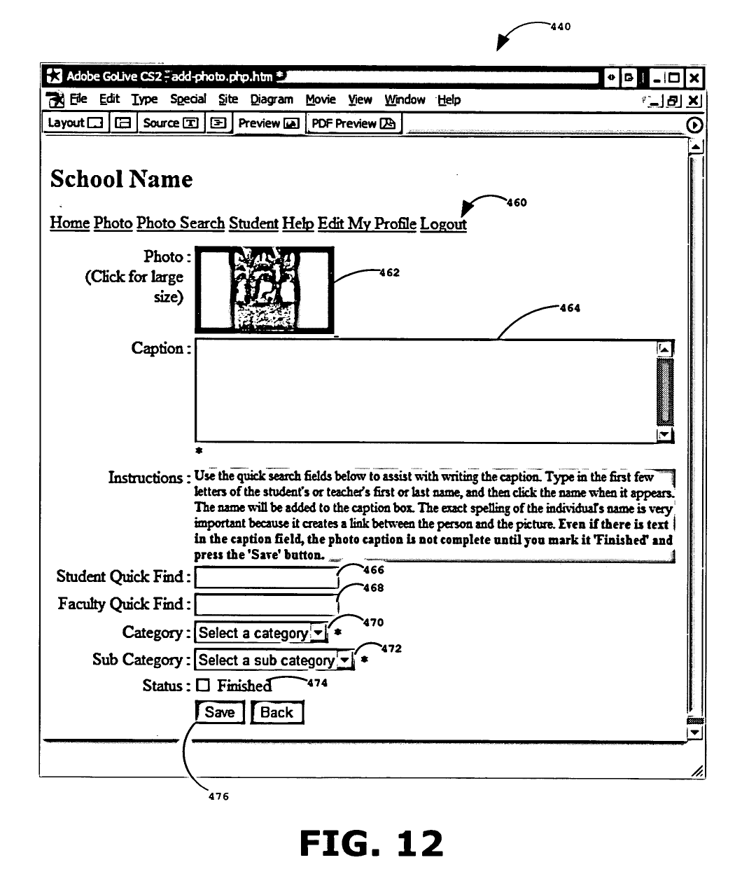

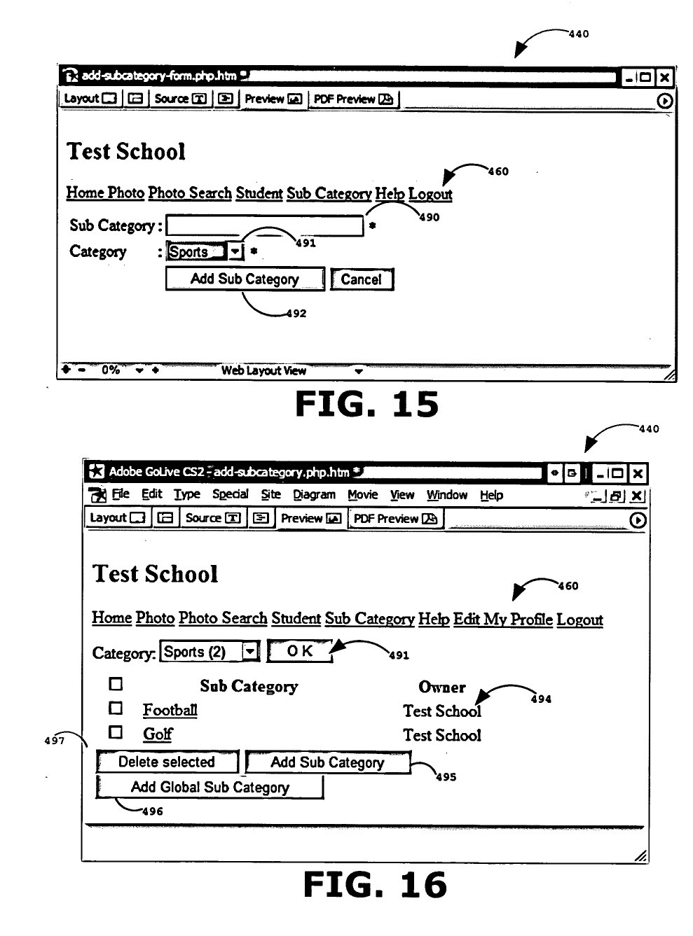

FIG. 12 shows a computer screenshot view illustrating system 440 displaying an interactive, browser based web page for associating roster names to digital medium according to another embodiment of the present invention. Navigation bar 460 displays hypertext links that navigate to other web pages in system 440, as shown. Photo field 462 display a photograph without captions or relationships to names in the roster, as shown. Caption field 464 allows entry and editing of the caption for the photograph, as shown. Student-find field 466 allows entry and editing of letters for selecting names from the roster, as shown. Faculty-find field 468 allows entry and editing of letters for selecting names from the roster, as shown. Alternately, system 440 can allow selection of names by present the proper roster name, but allowing selection of the name from the letters comprising a person's nick name. Category field 470 allows entry and editing of a classification for the photograph, as shown. Sub-category field 472 allows entry and editing of a sub-classification for the photograph, as shown (see also FIG. 15 and FIG. 16 below). Finished-boolean 474 allows entry and editing of a flag that indicates whether the caption is complete. System 440 may not allow finished-boolean 474 to indicate that the photograph has a completed caption if the caption field contains no text. Click save button 476 saves the caption and the relationships to system 440, as shown.

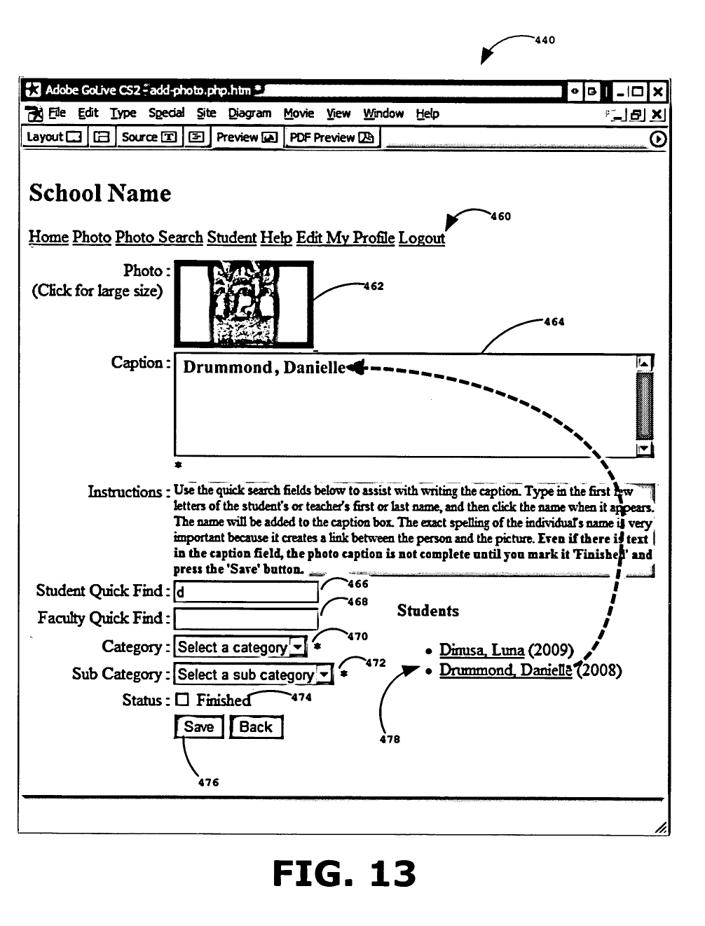

FIG. 13 shows a computer screenshot view illustrating system 440 displaying members names appearing after keystrokes are transmitted according to the embodiment of FIG. 12. Student list 478 displays student names as hypertext links. Clicking the student name will insert the text of the student name into caption field 464, as shown.

FIG. 14 shows a computer screenshot view illustrating searching for photos to associate with member's names according to the embodiment of FIG. 12. Keyword field 480 allows for entry and editing of keyword search criteria, as shown. Status-select field 482 allows for entry and editing of search criteria for photo caption status, as shown. Caption-status field 484 allows for entry and editing of search criteria for whether the caption field contains any text, as shown. Category-select fields 486 allow for entry and editing of the search criteria for categories, as shown. Clicking search button 488, transmits the search criteria and returns a web page with a list of photographs that may be selected for captioning.

Relationships between students and photos may be stored in a relational database table. For example, the following table definitions may be suitable for storing such information in a relational database.

emomem_to_photo

| field | type | null | default |
|---|---|---|---|
| Emophoid | int(10) | no | |
| schoolid | int(10) | no | 0 |
| subid | int(10) | no | 0 |
| emomemid | int(9) | no | 0 |
| photoid | int(10) | no | 0 |

Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, flat files, etc., may suffice.

FIG. 15 shows a computer screenshot view illustrating system 440 displaying a web page for adding sub-categories for classifying digital media according to the embodiment of FIG. 12. Sub-category field 490 allows entry and editing for sub-category names, as shown. Category field 491 allows selection of a parent category, as shown. Category field 491 may be a predetermined, fixed list of categories, such as, for example, activities, campus, clubs, events, sports, etc. Alternately, category field 491 may be user definable in the same manner as sub-category field 490. Clicking add-sub-category button 492 saves the sub-category record to system 440, as shown.

FIG. 16 shows a computer screenshot view illustrating system 440 displaying a web page for maintaining sub-categories for classifying digital media according to the embodiment of FIG. 12. Sub-category selection-boxes 494 allow selection of sub-categories. Clicking delete button 497 deletes sub-categories whenever the related sub-category selection boxes 494 are checked. Clicking add-global button 497 adds sub-categories to every category whenever the related sub-category selection boxes 494 are checked. Clicking add-sub-category button navigates to the web page illustrated in FIG. 15.

Classifications of photographs may be stored in a relational database table. For example, the following table definitions may be suitable for storing such information in a relational database.

| | | |
|---|---|---|
| type | null | default |

category
Categories

| | | |
|---|---|---|
| field | | |
| catid | tinyint(1) | no |
| category | varchar(50) | no |

emomem_to_subcategory

| | | | |
|---|---|---|---|
| emosubid | int(10) | no | |
| emomemid | varchar(11) | no | 0 |
| subid | int(10) | no | 0 |

subcategory

| | | | |
|---|---|---|---|
| Field | | | |
| subid | int(10) | no | |
| catid | tinyint(3) | no | 0 |
| ord | mediumint(8) | no | 0 |
| subcat | varchar(50) | no | |
| schoolid | int(11) | no | 0 |

Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, flat files, etc., may suffice.

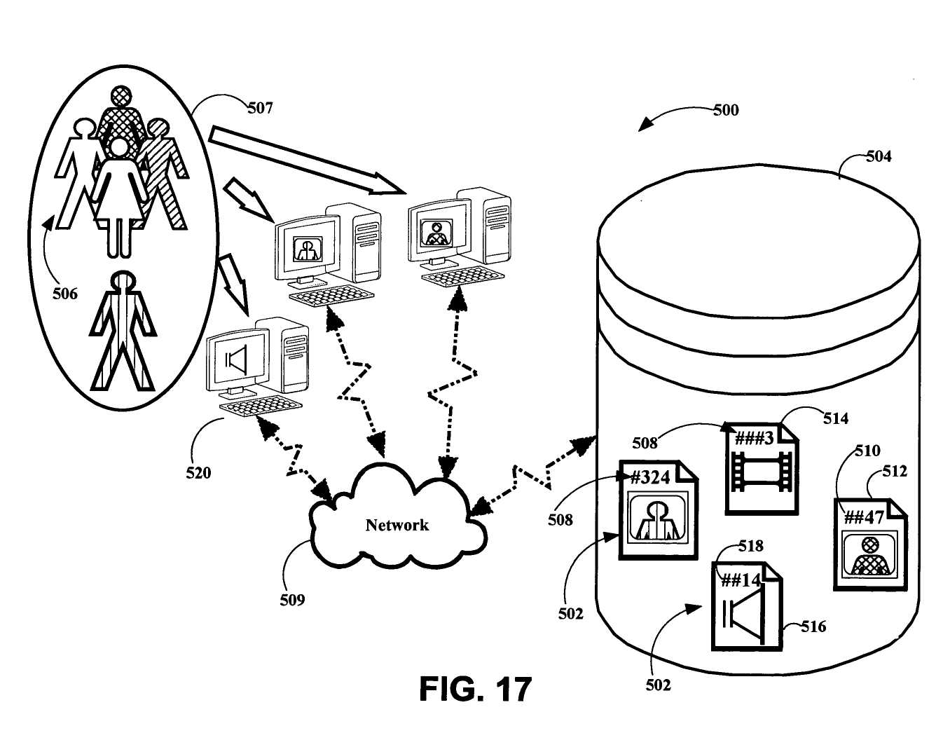

FIG. 17 shows a diagram view illustrating system 500 counting usage of digital media 502 according to another embodiment of the present invention.

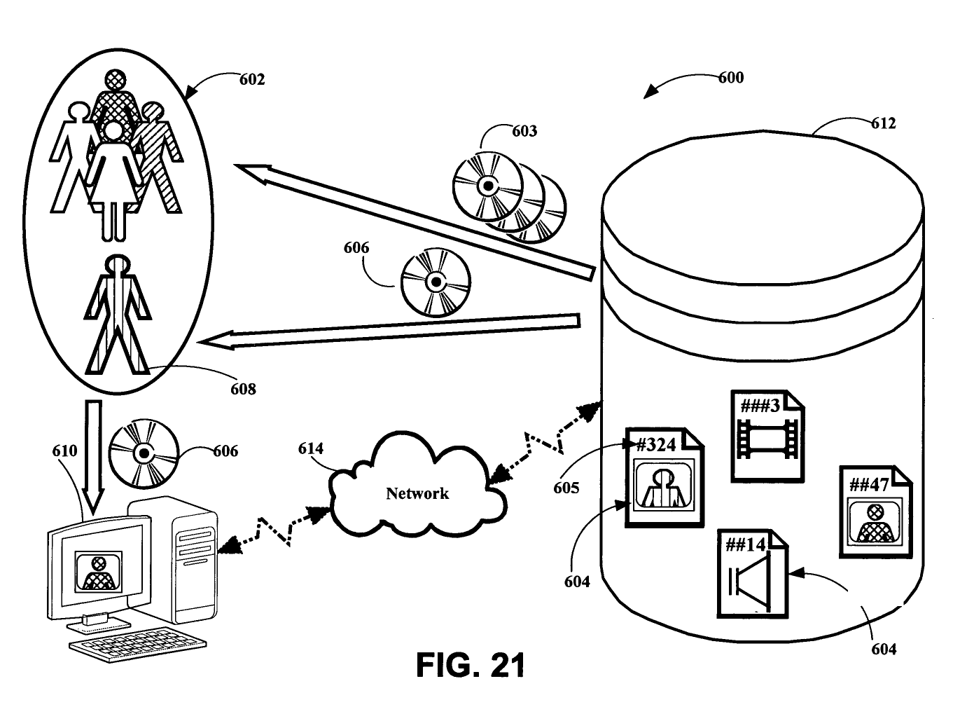

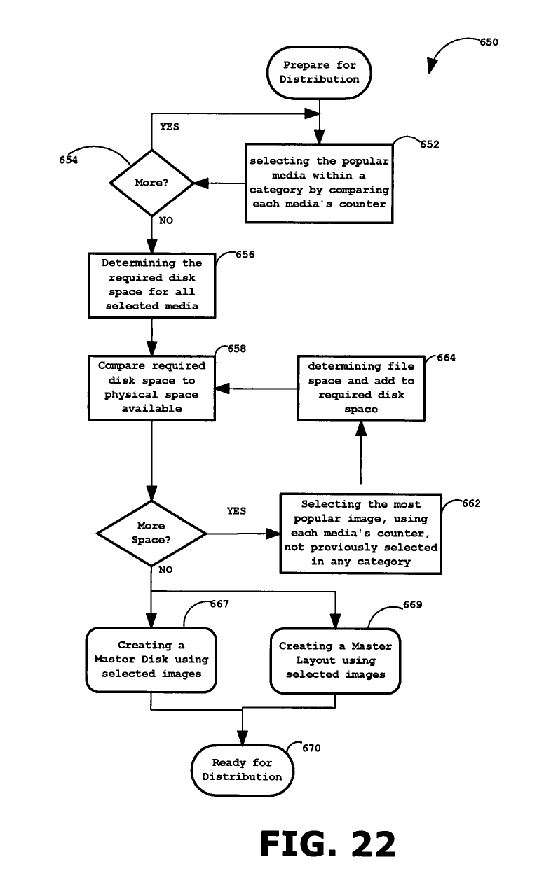

Database 504 may permit members 506 to access digital media 102 that belongs to organization 507, after members 506 prove their association with organization 507, such as, for example, by providing a username and related passwords to an account corresponding to the roster of organization 507. Alternately, database 504 may permit members 506 to access digital media 102 that belongs to organization 507, after members 506 prove their association with organization 507, such as, for example, by providing a CD-ROM or other physical key distributed to members 506 of organization 507 (see FIG. 21, below). Alternately, members 506 may indicate association with organization 507 by present their username and related password. Database 504 may permit members 506 to request electronic transmission of digital media 102, after authenticating members 506, over electronic network 509. Database 504 will increment counters 508 for each transmission of digital media 502. For example, database 504 may increment counter 510 each time members 506 view photograph 512 through a web browser. For example, database 504 may increment counter 510 each time members 506 send photograph 512 to a cellular phone. For example, database 504 may increment counter 510 each time members 506 vote for photograph 512 as a favorite photo from a set of photos. For example, database 504 may increment a digital media's counter each time members 506 choose to send the digital medium to a friend. Database 504 may increment a counter for other reasons, such as, for example, viewing a movie, adding content to the home page of members 506, downloading mp3 files to the mp3 players of members 506, etc. Database 504 collects usage information from the activities members 506 perform with digital media 502.

Database 504 contains a variety of digital media 502, as shown. Database 504 contains movie 514, which has a counter value of 3, meaning this movie has been viewed three times. Database 504 contains audio recording 516, which has counter 518 with a value of 14, as shown. Computer 520 just downloaded audio recording 516, causing database 504 to increment counter 518, as shown.

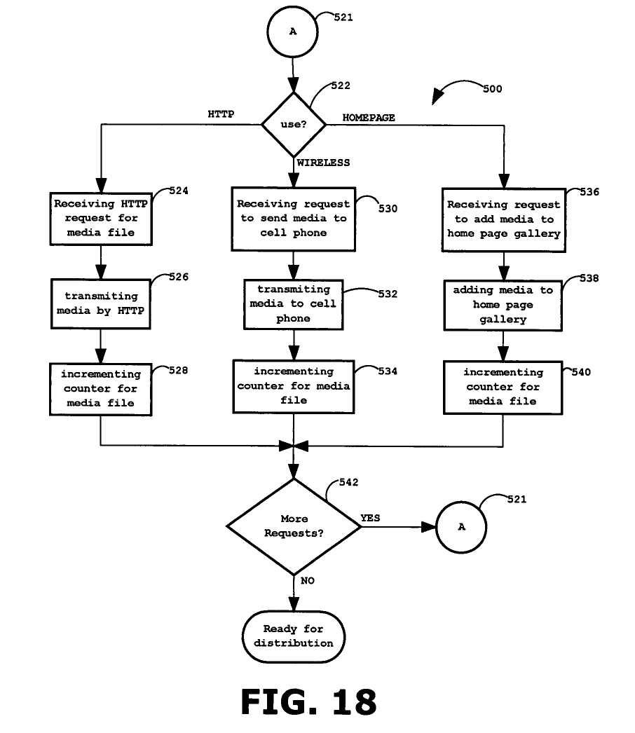

FIG. 18 shows a flowchart view illustrating system 500 counting usage of digital media according to another embodiment of the present invention. Starting from connector 521, system 500, during step 522, determines the usage type of the request, such as, for example, Internet web request (HTTP), wireless cellular phone network request, home page gallery request, etc. During step 524, system 500 receives a request to transmit the media file by HTTP, as shown. During step 526, system 500 transmits the media via HTTP. During step 528, system 500 increments the counter for the media file.

During step 530, system 500 receives a request to transmit the media file by wireless telephone network, as shown. During step 532, system 500 transmits the media to the cellular phone. During step 534, system 500 increments the counter for the media file.

During step 536, system 500 receives a request to add the media file to the homepage gallery of a member. During step 538, system 500 adds the media file to the member's homepage gallery. During step 540, system 500 increments the counter for the media file.

During step 542, system 500 determines if there are more requests which to respond, until the system is prepared for distribution of digital media using the counters for media files.

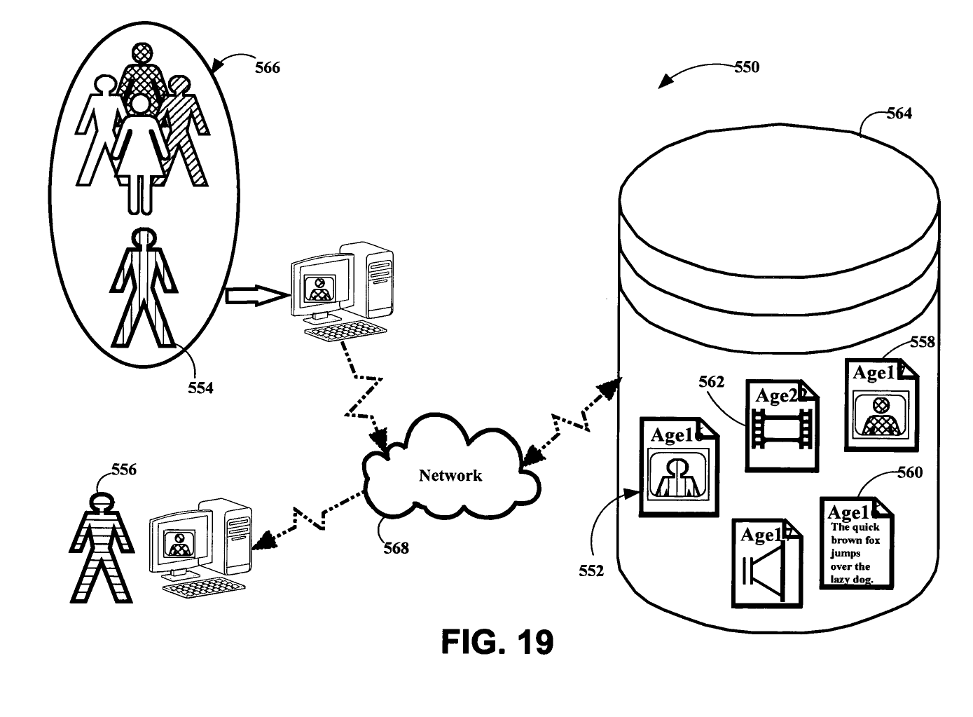

FIG. 19 shows a diagram view illustrating system 550 restricting transmitting of digital content 552 according to another embodiment of the present invention. Member 554 is 16 years of age and a junior in high school. Former member 556 is 20 years of age and graduated 2 years ago. Member 554 creates photo 558 and uploads photo 558 to database 564, as shown. Photo 558 is created by member 554 who is associated with organization 566. Photo 558 is indicated with “Age 17” meaning it is created by a poster having the age of 17. Member 556 authenticates with database 564, as shown. Former member 556 requests photo 558, as shown. Database 564 determines the age of former member 556, which is 20. Since the age of former member 526 is over the age of 18, database 564 determines the age of the poster of photo 558, which is member 554, who has an age of 17, as shown. Since the poster's age is under 18 years, database 564 next determines whether the member 554 and member 556 share an organizational association. Former member 556 is associated with organization 566 as a graduate and former member. Member 554 is associated with organization 566 as a member and junior classmen. Finally, database 564, determines whether the age difference between the poster and requester, i.e., member 554 and former member 556, is within an effective range. In this example, member 554 and former member 556 are both members of the same high school which has a four-year program, therefore, an effective age range is plus or minus three years. Since 17 years of age is within 3 years of 20 years of age, database 564 allows transmitting of photo 558 to former member 556, as shown. Upon reading the teachings of this specification, those with ordinary skill in the art will now realize that, under appropriate circumstances, considering such issues as advances in technology, economic considerations, user preference, etc., other methods for estimating, calculating or determine the age-difference, such as, for example, using the age range of a youth sport league, using the age range for the number of years of a education program, using the age range for other age-restricted activities, etc., may suffice.

Database 564 would not allow former member 556 access to digital content 560. Digital content 560 is indicated with an age of 16, which indicates more than three years between the poster's age of 16 and the requester's age of 20. Database 564 may allow public access to digital content 562, which has a poster's age of 22, which is older then the age of majority, and is therefore unregulated. Database 564 may require an Path, declaration, contract, agreement, or other promise, after graduation, that a member has actually attained the age of majority, such as, for example, 18 years. Upon reading the teachings of this specification, those with ordinary skill in the art will now realize that, under appropriate circumstances, considering such issues as advances in technology, changes in the age of majority, economic considerations, user preference, etc., other methods for determining a regulated or unregulated age may suffice.

Database 564 may allow posters of regulated and unregulated age to author a variety of digital content, such as, for example, digital media, email, blog posts, instant messages, guestbook, etc. Database 564 may apply these access rules to digital content stored in database 564. Upon reading the teachings of this specification, those with ordinary skill in the art will now realize that, under appropriate circumstances, considering such issues as advances in technology, advances in Internet communications, economic considerations, user preference, advances in digital content file formats, etc., other types of digital content, such as, for example, instant messages, comments on photos, news items, comments on news items, etc., may suffice.

Digital content may be stored in a relational database table. For example, the following table definitions may be suitable for storing such information in a relational database.

| | | | |
|---|---|---|---|
| field | type | null | default |

blog

| | | | |
|---|---|---|---|
| blogid | int(10) | no | |
| emomemid | int(9) | no | 0 |
| subject | varchar(255) | no | |
| body | mediumtext | no | |
| fromemid | int(9) | yes | null |
| fblogid | int(10) | yes | null |
| dts | datetime | no | 0000-00-00 |
| | | | 00:00:00 |

comment

| | | | |
|---|---|---|---|
| commentid | int(10) | no | |
| pictureid | int(10) | no | 0 |
| emomemid | int(9) | no | 0 |
| comment | mediumtext | no | |
| dts | datetime | no | 0000-00-00 |
| | | | 00:00:00 |

enote

| | | | |
|---|---|---|---|
| enoteid | int(10) | no | |
| enotetypeid | tinyint(1) | no | 0 |
| emomemid | int(9) | no | 0 |
| fromemid | int(9) | no | 0 |
| subject | varchar(255) | no | |
| body | mediumtext | no | |
| dts | datetime | no | 0000-00-00 |
| | | | 00:00:00 |

enotetype

| | | |
|---|---|---|
| enotetypeid | tinyint(1) | no |
| enotetype | varchar(25) | no |

guestbook

| | | | |
|---|---|---|---|
| guestbookid | int(10) | no | |
| emomemid | int(9) | no | 0 |
| memberid | int(11) | no | 0 |
| body | mediumtext | no | |
| dts | datetime | no | 0000-00-00 |
| | | | 00:00:00 |

Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, flat files, etc., may suffice.

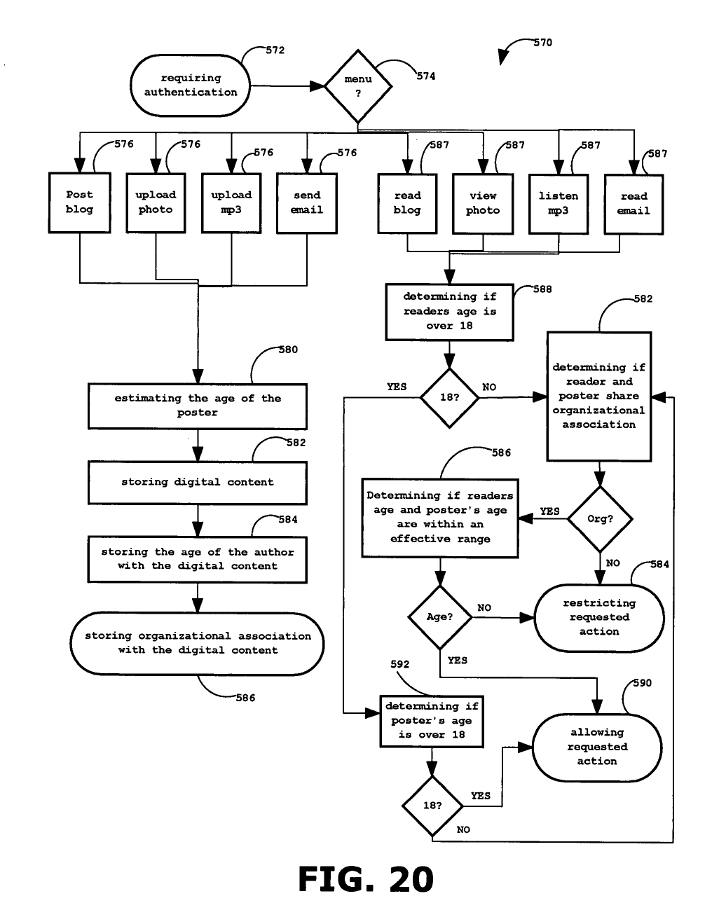

FIG. 20 shows a flowchart view illustrating system 570 restricting transmitting of digital content according to another embodiment of the present invention. System 570 requires that users authenticate during step 572. During step 574, system 570 presents a menu or navigation bar with options for positing digital content or viewing digital content. During step 576, system 570 allows posting of digital content, such as, for example, blog posts, photos, enotes (email, instant messages, etc.), uploading mp3s, etc. During step 580, system 570 estimates the age of the poster, such as, for example, asking for the posters birth date or age during account creation, relating the poster's school grade to the average age for that school grade (senior=17 years, junior=16 year, sophomore=15 years, freshman=14 years, during high school), etc. During step 582, system 570 stores the digital content. During step 584, system 570 stores the age of the poster with the digital content. During step 586, system 570 stores the organizational association with the digital content, such as, for example, what school the poster attends.

During step 587, system 570 responds to a request to view digital content. During step 588, system 570 determines if the age of the poster is over the regulated age, for example, 18 years of age. During step 582, system 570 determines whether the reader and the poster share an organizational association, such as, for example, both attend the same school. During step 584, system 570 restricts the requested action whenever the reader's age is under 18 and the reader and poster do not share an organizational association.

During step 586, system 570 determines whether the reader's and poster's age are within an effective age range, such as, for example, no more than three years difference, which corresponds to the number of years in the school curriculum, thereby, system 570 emulates the social relationships that could have occurred naturally in the physical environment of the school. During step 584, system 570 restricts the requested action whenever the reader's age is under 18 and the reader and poster do share an organizational association but the age difference between the reader and poster exceeds an effective range.

During step 590, system 570 allows the requested action whenever the reader's age is under 18, the reader and poster share an organizational association, and the age difference between the reader and poster is within an effective range.

During step 592, system 570 determines if the age of the poster is over the regulated age. During step 590, system allows the requested action whenever the reader's age is over the regulated age and the poster's age is over the regulated age.

Upon reading the teachings of this specification, those with ordinary skill in the art will now realize that, under appropriate circumstances, considering such issues as the age of majority, school curriculums, legal regulation of internet content, Child Online Privacy Protection Act, age of graduation, user preference, economic considerations, etc., other regulated and unregulated ages, such as, for example, 13, 18, 21, etc., may suffice.

Upon reading the teachings of this specification, those with ordinary skill in the art will now realize that, under appropriate circumstances, considering such issues as the age of majority, school curriculums, legal regulation of internet content, Child Online Privacy Protection Act, age of graduation, user preference, economic considerations, etc., other effective age differences, such as, for example, one year difference, two years difference, four years difference, etc., may suffice.

FIG. 21 shows a diagram view illustrating system 600 distributing digital media to organization 602 according to another embodiment of the present invention. System 600 selects digital media 604 for distributing using counters 605, thereby indicating a preference for popular digital media, as shown. System 600 categorizes digital media 604 for distribution using categories, as described in FIG. 12-13, 15-16, above. System 600 selects digital media 604 for distribution using both counters 605 and categories in combination. System 600 may resolve digital media 604 into low resolutions and high resolutions, such as, for example, for photos, smaller dimensions or higher compression; for audio records, resampling to a lower frequency or using higher, lossy compression settings; for movies, resampling to a lower frame rate or resizing to a smaller image size; etc. System 600 may select digital media 604 for distribution based on all or a combination of these factors. System 600 may select digital media 604 based on the availability of file storage space on the physical media, such as, for example, no more than approximately 700 megabytes (MB) for compact-disk read-only-memory (CD-ROM), no more than approximately 4.7 gigabytes (GB) for digital video disk (DVD), no more than a predefined number of pages for a physical book, etc.

System 600 further divides digital media 604 into a free portion and a paid portion. System 600 may select digital media for the free portion based on popularity, category, resolution, quantity, file size, etc. System 600 may select digital media 604 for the paid portion based on popularity, category, resolution, quantity, file size, etc. System may also select digital media 604 for the paid portion as the remainder of all content not selected for the free portion.

System 600 may lock digital media included in the paid portion to frustrate copying and performance access unless and until a fee is paid. System 600 may encrypt digital media 604 prior to distribution. System 600 may password protect digital media 604 to assist in frustrating copying. System 600 may use protected cast libraries in Adobe director to further frustrate copying and access. System 600 may use JavaScript to prevent “right click and save” from web pages generated by system 600. System 600 may distribute paid, locked portions by electronic network. System 600 may distribute paid, locked portions by physical media.

System 600 may distribute digital media by electronic-network. System 600 distributes digital media by physical media 603. System 600 may distribute digital media by combinations of electronic-network and physical media. System 600 may distribute paid portions and free portions by electronic-network. System 600 may distribute paid portions and free portions by physical media. System 600 may distribute digital media directly to organization 602 using a free physical media, such as, for example, a compact disk or DVD.

System 600 may supplement digital media distribution by distributing additional digital media after physical distribution of physical media 603. For example, this is useful for schools to distribute yearbooks on CD-ROM prior to graduation and supplement the CD-ROM distribution with other digital media created during late school year events, such as, graduation. System 600 may configure CD-ROMs with unique keys or encryption codes to uniquely identify the school and grade, wherein, system 600 may then prevent access to digital media created at such late school year events without CD-ROM. System 600 may configure CD-ROM with decryption software needed to open locked, paid digital media.

For example, CD-ROM 606 is distributed to member 608. Member 608 uses CD-ROM 606 in computer 610, as shown. Computer 610 accesses database 612 using electronic-network 614, as shown. Computer 610 passes key from CD-ROM to database 612. Database 612 identifies key as associated with a particular school. Database 612 may identify key as associated with a particular grade level.

FIG. 22 shows a flowchart view illustrating system 650 distributing digital media according to another embodiment of the present invention. To prepare for distribution of digital media, during step 652, system 650 identifies all digital media within a category and sub category. Then system 650 determines the digital media within that sub category that has the highest counter, which would be set by the processes described in FIG. 18 and FIG. 19. System 650 would select a predetermined number, e.g., 10 digital media per sub-category, or a predetermined size, e.g., 20 MB per sub category, or a combination.

During step 654, system 650 determines if any other categories remain for selecting popular media. During step 656, system 650 will determine the amount of space available on the physical media. For example, on a DVD disk, about 4.7 GB are available, on a CD-ROM disk, about 700 MB are available, in a book, there will be a limited number of pages and possibly a minimum number of pages, etc. System 650 determines the amount of space that each selected digital media would occupy on the physical media. For example, a digital photo, digital movie, digital audio recording would all occupy a certain file size on a DVD or CD-ROM disk. For example, a digital photo, when printed in a book, will occupy a certain portion of a page or pages within the book.

During step 658, system 650 compares the space required by the selected digital media to the physical space available. When there is more space available, system 650 will continue to select images. When there is not enough physical space available, system 650 will eliminate selected images until all selected images can occupy the physical space. System 650 may eliminate images in the order of least popularity.

During step 662, system 650 selects the most popular image that has not been previously selected. System 650 may determine popularity using the media counter associated with each image (which is described above in the discussion related to FIG. 17 and FIG. 18). System 650 may determine popularity through other means. During step 664, system 650 will determine the space requirements, physical, file or otherwise, for the newly selected image and continue on to step 658.

During step 667, system 650 creates a master disk using the selected digital media, such as, for example, gold CDROM master, an ISO file containing information necessary to create CDROMs or DVDs, etc. During step 669, system 650 creates a layout file used to produce a book, such as, for example, a press-ready Adobe Acrobat file, a Page Maker file, an XML template, etc. System 650 may create other master disks, layouts, or schemes for use in manufacturing other physical media.

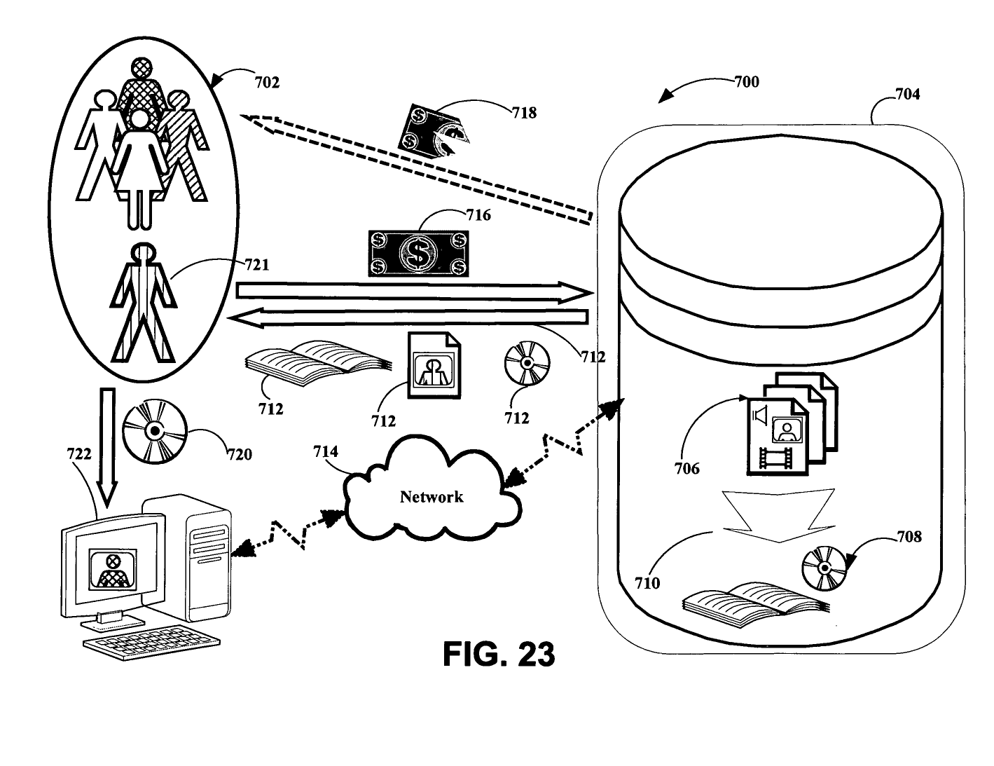

FIG. 23 shows a diagram view illustrating system 700 sharing revenue associated with the distribution of digital media according to another embodiment of the present invention. Organization 702 contracts with service provider 704 to collect, caption, store, distribute, manufacture, or any combination, digital media 706 of organization 702, as shown. Service provider 704 manufactures physical media 708 using manufacturing process 710, as shown. Manufacturing process 710 can produce CDROMS, DVDS, books, websites, eBooks, yearbooks, memory books, scrap books, group photos, etc. Physical distribution process 712 delivers the physical media 708 to members of organization 702. Alternately, electronic distribution may use electronic network 704. Alternately, both physical and electric distribution process can be used.

Service provider 704 collects fee 716 during physical distribution process 712 or electronic distribution or both, as shown. Service provider 704 pays fee portion 718 to organization 702, as shown.

Alternately, member 724 can use the physical medium 720 to allow electronic distribution of digital media 706, as shown. Member 724 can place physical media 720 into computer 722, as shown. Computer 722 can transmit encryption keys, identifiers, or other indicia of the organization, date of publication, or indicia of the physical media itself that has been included on physical media 720. Service provider 704 can use this information from physical media 720 to identify organization 702, related digital media 706, and related physical media 708. Service provider 704 may rely on the physical possession of physical media 720 to indicate an association with organization 702. Service provider 704 may then provide electronic distribution to the holder of physical medium 720, as shown.

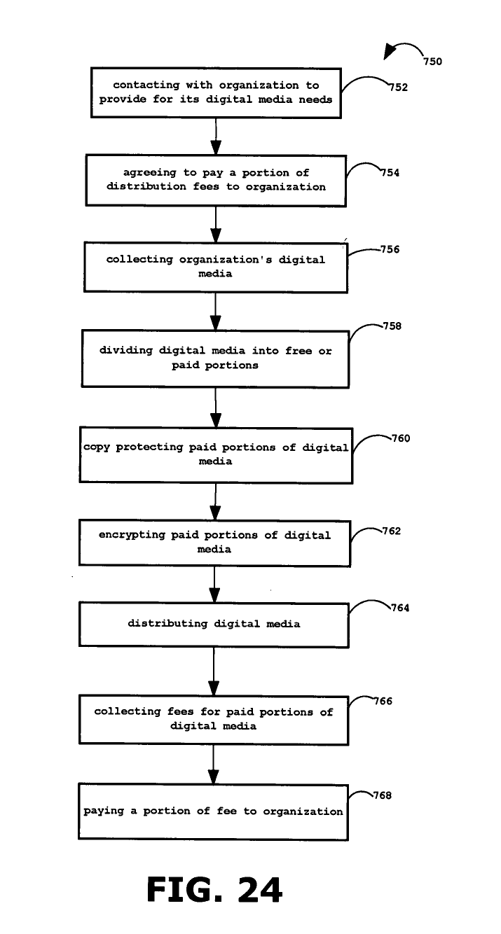

FIG. 24 shows a flowchart view illustrating system 750 sharing revenue associated with the distribution of digital media according to another embodiment of the present invention. During step 752, a service provider contracts with an organization to provide a service for collecting, captioning, categorizing and distributing the digital media and other digital content for members and former members of the organization. In exchange, the organization allows the service provider to charge fees for distribution of the digital media content to its members.

During step 754, the service provider agrees to pay a portion of the fees collected by the service provider to the organization. This step may occur in the document as step 752, or this step may be a separate document, or any other arrangement. This arrangement can have a variety of terms, such as, for example, the service provider can pay the fees quarterly, but collect the fee immediately. For example, the service provider can pay and collect the fee immediately. For example, the service provider can pre-sell gift certificates that are not earned until used for distribution of paid content, and the fee will not be paid until the paid content is downloaded and the gift certificate is redeemed (of course, the gift certificate could have many names, including, for example, download credits or tokens, etc.)

During step 756, the service provider collects the digital media. The service provider may use any combination of embodiments described in the various figures herein to collect, caption, categorize or distribute the media, or other methods.

During step 758, the service provider divides the media into at least one free portion and at least one paid portion. For example, the free portion could be provided on a physical media only. For example the free portion could be provided electronically only. For example, a combination of free and paid portions could be provided on physical media. For example, a combination of free and paid portions could be provided electronically.

During step 760, the service provider copy protects the paid portion of the digital media to frustrate copying efforts. For example, the service provider may use protected cast libraries in Adobe director to further frustrate copying and access. For example, the service provider may use JavaScript to prevent “right click and save” from web pages. Upon reading the teachings of this specification, those with ordinary skill in the art will now realize that, under appropriate circumstances, considering such issues as advances in copy protection technology, economic considerations, user preference, advances in digital image file types, advances in physical media, advances in distribution technology, etc., other methods of frustrating copying, such as, for example, hardware tokens, encryption, etc., may suffice.

During step 762, the service provider may encrypt the paid portion of the digital media. The service provider may provide the software, encryption keys, or both, within the physical media.

During step 764, the service provider may distribute the digital media to the organization's members. The service provider may distribute only the free portions. The service provider may distribute paid portions in locked formation.

During step 766, the service provider collects fees for paid portions. The service provider may distribute the paid portions. The service provider may distribute keys or decryption keys, software or techniques to allow the purchaser to view, listen, watch or otherwise perform the digital media. The service provider may use the physical media, and identifying keys stored therein, to determine which digital content may be purchased. For example, if the organization is a school, and the purchaser is a former member or graduate, the service provider may rely on the physical possession of the CD ROM as an indication that the purchaser was actually a former student of the school and is entitled to purchase and view the digital content related to that organizations activities during the years that the purchaser attended school. For example, the CDROM will contain a key or keys that can identify at least the organization and the date of distribution.

During step 766, the service provider may sell credits to the members of the organization, such as, for example, 50 credits for $5, 2500 credits for $50. Member use credits to download, unlock, or perform the digital media. Each credit may allow distribution of one digital medium. Alternately, each credit may allow for a certain amount of transmission, such as, for example, 10 MB of downloading from the service provider's website. Alternately, credits can be another way the service provider can divide the free and paid portions. For example, during step 758, the service provider can treat all digital media as a paid portion and distribute a limited amount of free credits to each member of the organization. The member can then use the credits to perform any digital media selected by the member.

During step 768, the service provider will pay the organization a portion of the fee collected. For example, the service provider may pay a percentage of all fees collected. For example, the service provider may pay a percentage on a graduated scale, paying more or less fees according to the number of digital media distributed. For example, the service provider may pay a portion of the fees for a limited period of time after distribution of the physical media. For example, the service provider may pay a portion of the fees after a minimum amount of fees have been collect or a maximum amount of fees have been collected.

Distribution information may be stored in a relational database table. For example, the following table definitions may be suitable for storing such information in a relational database.

| | | | |
|---|---|---|---|
| field | type | null | default |

cd-rom_to_school

| | | | |
|---|---|---|---|
| cd-romid | mediumint(8) | no | |
| schoolid | mediumint(8) | no | 0 |
| year | mediumint(8) | no | 0 |

cd-rom_to_year

| | | | |
|---|---|---|---|
| cd-romtoyearid | int(10) | no | |
| cd-romid | mediumint(8) | no | 0 |
| yearid | mediumint(4) | no | 0 |

cd-rom_to_year_to_classlevel

| | | | |
|---|---|---|---|
| cd-romtoyeartoclasslevelid | int(10) | no | |
| cd-romtoyearid | int(10) | no | 0 |
| classlevelid | int(10) | no | 0 |

Upon reading the teachings of this specification, those with ordinary skill in the art will now realize that, under appropriate circumstances, considering such issues as advances in information storage technology, economic considerations, user preference, etc., other types of storing, such as, for example, hierarchical database, custom database schemes, linked lists, object-oriented database, flat files, etc., may suffice.

A portion of the disclosure of this patent application contains material which is subject to copyright protection; i.e. Copyright 2006 Harver Group LLC (17 U.S.C. 401). The copyright owner has no objection to the facsimile reproduction by anyone of the patent document or the patent disclosure, as it appears in the Patent and Trademark Office patent file or records, but otherwise reserves all copyright rights whatsoever.

Although applicant has described applicant's best mode and other embodiments of this invention, it will be understood that the broadest scope of this invention includes such modifications as diverse technologies, software languages, business customs, etc. Such scope is limited only by the below claims as read in connection with the above specification. Further, many other advantages of applicant's invention will be apparent to those skilled in the art from the above descriptions and the below claims.

What is claimed is:

1. A system comprising:
permitting authoring of at least one digital-content by at least one first person; and
restricting transmitting, across at least one globally-connected electronic-network, of said at least one digital-content to at least one second person;
wherein the step of restricting electronically transmitting comprises the steps of
determining the age of said at least one first person;
determining the age of said at least one second person;
allowing electronically transmitting whenever the age of said at least one first person is unregulated and the age of said at least one second person is unregulated; and
allowing electronically transmitting whenever
the age-difference between the age of said at least one first person and the age of said at least one second person, differ by less than at least one effective amount,
said at least one first person is associated with at least one organization, and
said at least one second person is associated with said at least one organization.

2. The claim of claim 1 wherein:
said at least one digital-content comprises at least one photograph.

3. The claim of claim 1 wherein:
said at least one digital-content comprises at least one audio recording.

4. The claim of claim 1 wherein:
said at least one digital-content comprises at least one movie.

5. The claim of claim 1 wherein:
said at least one digital-content comprises at least one text.

6. The claim of claim 5 wherein:
said at least one digital-content comprises at least one blog post.

7. The claim of claim 5 wherein:
said at least one digital-content comprises at least one instant message.

8. The claim of claim 5 wherein:
said at least one digital-content comprises at least one email.

9. The claim of claim 1 wherein:
said at least one digital-content comprises at least one digital-content selected from the group consisting of photograph, audio recording, movie, text, blog post, instant message, email, and combinations thereof.

10. The claim of claim 1 wherein:
said at least one organization comprises at least one school.

11. The claim of claim 1 wherein:
said at least one organization comprises at least one religious group.

12. The claim of claim 1 wherein:
said at least one organization comprises at least one athletic team.

13. The claim of claim 1 wherein:
the step of determining the age of said at least one first person further comprises the step of estimating the age of said at least one first person using the school grade-level of said at least one first person; and
the step of determining the age of said at least one second person further comprises the step of estimating the age of said at least one second person using the school grade-level of said at least one second person.
